(19) United States
(12) Patent Application Publication
(10) Pub. No.: US 2020/0102462 A1
(43) Pub. Date: Apr. 2, 2020

(54) AQUEOUS EFFECT-PIGMENT PASTES CONTAINING A POLYMERIZATE, AND BASECOATS PRODUCED THEREFROM

(71) Applicant: BASF Coatings GmbH, Muenster (DE)

(72) Inventors: Patrick Wilm, Muenster (DE); Dirk Eierhoff, Muenster (DE); Juergen Bauer, Graefelfing (DE); Carola Ulrike Jahn, Muenster (DE)

(21) Appl. No.: 16/495,307

(22) PCT Filed: Mar. 22, 2018
(86) PCT No.: PCT/EP2018/057342

§ 371 Date: Sep. 18, 2019

(30) Foreign Application Priority Data
Mar. 23, 2017 (EP) 17162526.2

(51) Int. Cl. C09D 5/36; C09D 17/00; B05D 7/00

(52) U.S. Cl. CPC C09D 5/36; B05D 7/532; C09D 17/007; C09D 17/001

(57) ABSTRACT

Described herein are an aqueous effect pigment paste including at least one effect pigment (a) and at least one polymer (b) which is preparable by successive radical emulsion polymerization of three monomer mixtures (A), (B) and (C) of olefinically unsaturated monomers in water, an aqueous basecoat material which is preparable by admixing the effect pigment paste to at least one aqueous binder-containing component suitable for preparing the basecoat material, a method for producing a multicoat paint system using this basecoat material, and use of the polymer (b) for dispersing effect pigments within an aqueous effect pigment paste.

The present invention relates to an aqueous effect pigment paste comprising at least one effect pigment (a) and at least one polymer (b) which is preparable by successive radical emulsion polymerization of three monomer mixtures (A), (B) and (C) of olefinically unsaturated monomers in water, to an aqueous basecoat material which is preparable by admixing the effect pigment paste to at least one aqueous binder-containing component suitable for preparing the basecoat material, to a method for producing a multicoat paint system using this basecoat material, and to use of the polymer (b) for dispersing effect pigments within an aqueous effect pigment paste.

### PRIOR ART

Pigment pastes and polymers used therein are known in the art. The use of pigment pastes in the coatings industry substantially facilitates the technically complex operation of pigment dispersing, since it ensures, for example, dust-free processing of pigments during the formulation of coating materials. As a result of incorporation into the paste, moreover, the pigments are optimally wetted and very well dispersed, and so an improved state of distribution is achieved in the resultant coating material as well. This results in improved technological performance properties on the part of the coating material and of the paint system produced therefrom, such as particularly homogeneous color or color distribution on the part of the paint system.

Pigment pastes containing effect pigment as well (effect pigment pastes) are for the same reasons initially produced separately as an intermediate before being incorporated into a coating material such as a waterborne basecoat material, since direct incorporation of these pigments into the coating material is accompanied by the problems identified above, particularly in relation to inadequate dispersing and wetting of the pigments in the case of direct addition.

In the production of pigment pastes in general and of effect pigment pastes in particular, precisely tailored polymers must be used as paste binders in order to obtain an optimally conditioned paste. Without individual adaptation and precise selection of the polymer, the pigment in question can usually not be optimally dispersed, and so, therefore, the technological performance properties of the ultimately resulting paint system are also not optimal.

Another problem here, often, is that the paste binder in question does not always correspond to the principal binder of the coating composition, and so the paste introduces a further binder component into the coating composition. As a result, the operation of producing the coating composition becomes more complex. Moreover, there is a loss of formulating freedom in the production of a coating material. The reason is that the use of a particular polymer in the paste may mean that other coating components in turn also have to be tailored to this polymer. Furthermore, there is less room for maneuver in the use of further additives and/or binder components in the coating, since their use may excessively lower, in particular, the fraction of the principal binder, which is of primary importance. If attempts are made to compensate the above disadvantages in formulation freedom by using a polymer (paste binder) in the paste that corresponds to the principal binder in the resulting coating composition, there are generally compromises that have to be made in terms of the choice of the principal binder and hence in the quality of the resultant coating composition and of the multicoat paint system produced with it—such compromises, however, are undesirable.

From an environmental standpoint, furthermore, it is desirable to use pigment pastes which are aqueous or have as low a level as possible of organic solvents.

Various methods for pasting/dispersing effect pigments in order to produce effect pigment pastes are known from the art. In U.S. Pat. No. 3,862,071 this is achieved using a mixture of a melamine-formaldehyde resin and a (meth)acrylic (co)polymer.

DE 103 50 719 A1 discloses effect pigment pastes which as well as an effect pigment comprise a (meth)acrylate copolymer present in a primary dispersion. These polymers described in DE 103 50 719 A1, however, have comparatively high glass transition temperatures, a factor which may result in inadequate adhesion properties.

Known from WO 2015/090811 A1 are aqueous pigment pastes which as well as a pigment such as an effect pigment comprise a polyurethane-based copolymer which is preparable by copolymerizing a mixture of olefinically unsaturated monomers in the presence of a polyurethane. Following incorporation into a coating composition such as a waterborne basecoat material, however, the pigment pastes disclosed in WO 2015/090811 A1 do not always lead to the desired pinhole robustness.

In the prior art, furthermore, there are effect pigment pastes known which comprise polyesters and also comparatively large amounts of organic solvents such as butyl glycol. Disadvantages of these effect pigment pastes, however, are their low storage stability and also their comparatively high solvent content and polyester content. Solvent-based effect pigment pastes of these kinds are described for example in WO 92/15405 A1.

EP 1 534 792 B1 discloses aqueous metallic pigment pastes which are free of binders, including dispersing resins, but must necessarily include among their components a nonassociative (meth)acrylic copolymer thickener. Corresponding aqueous mica pigment pastes are known from EP 1 504 068 B1. A disadvantage of these effect pigment pastes, however, is that a thickener must necessarily be used in their preparation, thus necessitating a comparatively large quantity of water, in production of coating materials such as waterborne basecoat materials using these pastes, in order to set a sufficient viscosity; a result of this in turn is an unwanted lowering in the solids content of the resultant coating material.

Lastly, EP 1 799 783 B1 discloses an aqueous effect pigment paste which as well as an effect pigment and a surface-active compound comprises a polyurethane-based graft copolymer. A disadvantage of these effect pigment pastes, however, is their comparatively low storage stability.

There is therefore a need for aqueous effect pigment pastes which do not have the disadvantages identified above.

### Problem

One problem addressed by the present invention, therefore, is that of providing an aqueous effect pigment paste which can be used for producing a basecoat material and has advantages over the effect pigment pastes known from the prior art. A particular problem addressed by the present invention is that of providing an aqueous effect pigment paste which has sufficient storage stability and as a result is suitable particularly for use in automated production. A further problem addressed by the present invention is the provision of an aqueous effect pigment paste which comprises as paste binder a polymer which can be used equally as principal binder in corresponding aqueous basecoat materials to be produced using the effect pigment paste. The aqueous basecoat materials produced accordingly ought to provide optimum fulfilment of the requisite technological performance properties, such as especially a good visual appearance, sufficient flop, and good adhesion properties, at any rate not detracting from these properties even if not actually being able to improve them.

### Solution

This problem is solved by the subject matter claimed in the claims and also by the preferred embodiments of that subject matter that are described in the description hereinafter.

A first subject of the present invention is therefore an aqueous effect pigment paste comprising

(a) at least one effect pigment and

(b) at least one polymer having an average particle size in the range from 100 to 500 nm, preparable by successive radical emulsion polymerization of three monomer mixtures (A), (B) and (C) of olefinically unsaturated monomers in water, where
the mixture (A) comprises at least 50 wt % of monomers having a solubility in water of less than 0.5 g/l at 25° C., and a polymer prepared from the mixture (A) possesses a glass transition temperature of 10 to 65° C.,
the mixture (B) comprises at least one polyunsaturated monomer, and a polymer prepared from the mixture (B) possesses a glass transition temperature of −35 to 15° C., and
a polymer prepared from the mixture (C) possesses a glass transition temperature of −50 to 15° C., and where
i. first the mixture (A) is polymerized,
ii. then the mixture (B) is polymerized in the presence of the polymer prepared under i., and
iii. thereafter the mixture (C) is polymerized in the presence of the polymer prepared under ii.

A further subject of the present invention is an aqueous basecoat material, wherein the basecoat material is preparable by admixing at least one effect pigment paste of the invention as component (1) to at least one aqueous component (2) which is suitable for preparing a basecoat material and which comprises at least one polymer which can be used as binder, this polymer which can be used as binder comprising the polymer (b) also present in the effect pigment paste, and/or comprising at least one polymer different therefrom. As is evident from the results of the experiments described in section 6.5 and table 6.8 of the experimental section hereinafter, this specific production of basecoat materials with the same composition but produced in different ways distinguishes the basecoat materials of the invention in terms of their properties such as, for example, in the incidence of bits.

A further subject of the present invention is a method for producing a multicoat paint system, by
(1a) applying an aqueous basecoat material to a substrate,
(2a) forming a polymer film from the coating material applied in stage (1a),
(1b) optionally applying a further aqueous basecoat material to the polymer film thus formed,
(2b) optionally forming a polymer film from the coating material applied in stage (1b),
(3) applying a clearcoat material to the resultant basecoat film(s), and subsequently
(4) jointly curing the basecoat film(s) together with the clearcoat film,

wherein a basecoat material of the invention is used in stage (1a) or—if the method further comprises stages (1b) and (2b)—in stage (1a) and/or (1b). The substrate used in stage (1a) preferably has an electrocoat film (EC), more preferably an electrocoat film applied by cathodic deposition of an electrocoat material, and the basecoat material used in stage (1a) is applied directly to the EC-coated substrate, the electrocoat film (EC) applied to the substrate being preferably cured during implementation of stage (1a).

A further subject of the present invention is a use of the polymer identified in connection with the first subject, i.e., of a polymer having an average particle size in the range from 100 to 500 nm, preparable by successive radical emulsion polymerization of three monomer mixtures (A), (B) and (C) of olefinically unsaturated monomers in water, where
the mixture (A) comprises at least 50 wt % of monomers having a solubility in water of less than 0.5 g/l at 25° C., and a polymer prepared from the mixture (A) possesses a glass transition temperature of 10 to 65° C.,
the mixture (B) comprises at least one polyunsaturated monomer, and a polymer prepared from the mixture (B) possesses a glass transition temperature of −35 to 15° C., and
a polymer prepared from the mixture (C) possesses a glass transition temperature of −50 to 15° C.,
and where
i. first the mixture (A) is polymerized,
ii. then the mixture (B) is polymerized in the presence of the polymer prepared under i., and
iii. thereafter the mixture (C) is polymerized in the presence of the polymer prepared under ii,

for dispersing effect pigments within an aqueous effect pigment paste. This dispersing represents premixing of the effect pigments using the polymer (b) in water.

It has surprisingly been found that the aqueous effect pigment paste of the invention is notable for outstanding storage stability and as a result is especially suitable for use in automated production.

It has further surprisingly been found that the polymer (b) present in the aqueous effect pigment paste of the invention not only can be used as a principal binder in aqueous basecoat materials but also, furthermore, can be used as a paste binder in an aqueous effect pigment paste. As a result, enhanced formulation freedom is acquired in the production of the basecoat material, since, as a result of the possibility now provided for the polymer (b) to be used in the effect pigment paste, there is no need for the other coating components of the basecoat material to be brought into line with a further paste binder different from the polymer (b). Moreover, there is consequently greater room for maneuver in the use of further additives and/or binder components in the basecoat material, since the use of the polymer (b) in the effect pigment paste as well means that in these cases the fraction of the principal binder of the basecoat material is not excessively lowered. It has in particular been surprisingly found that in spite of the use of the polymer (b) both as paste binder in the effect pigment paste and as principal binder of the resultant basecoat material, there are no disadvantages in the quality of the resultant coating composition and of the multicoat paint systems produced therewith, in terms, for example, of technological performance properties such as a good visual appearance (incidence of pops and runs), sufficient flop and hue, and also good adhesion properties.

### DETAILED DESCRIPTION

The term “comprising” in the sense of the present invention, in connection with the effect pigment paste of the invention and also in connection with the basecoat material of the invention, preferably has the meaning of “consisting of”. In this case it is possible, both for the effect pigment paste of the invention—besides components (a), (b) and water—and for the basecoat material of the invention—besides components (1), (2) and water—for one or more of the further components stated below and present optionally in the effect pigment paste of the invention and/or in the basecoat material of the invention to be present in said paste and/or said material. All of these components may each be present in their preferred embodiments as stated below.

Effect Pigment Paste of the Invention

The pigment paste of the invention is an effect pigment paste. The concept of the pigment paste is known to the skilled person and is defined for example in Rompp Lexikon, Lacke and Druckfarben, Georg Thieme Verlag, 1998, 10th edition, page 452: Pigment pastes are preparations of pigment mixtures in carrier materials such as polymers, comprising the pigments at a concentration higher than that of the subsequent application. An effect pigment paste, accordingly, is a pigment paste which comprises as pigment at least one effect pigment—namely at least one effect pigment (a). The subsequent application of pigment pastes lies in general in the production of coating compositions such as basecoat materials. A pigment paste is therefore distinguished from a coating composition such as a basecoat material in that it represents only a precursor to the production of such a coating composition. A pigment paste as such can therefore not itself be used as basecoat material. In pigment pastes, customarily, the relative weight ratio of pigments to polymers is greater than in the coating compositions for whose production the paste is eventually used. Besides the carrier materials such as polymers, also called paste binders, and pigments, the pigment paste customarily comprises water and/or organic solvents as well. Various additives such as wetting agents and/or thickeners may also be used in a pigment paste. The polymer (b) present in the effect pigment paste of the invention is used as a pigment paste binder (paste binder). The effect pigment paste of the invention represents an aqueous composition comprising components (a) and (b).

The effect pigment paste of the invention is aqueous. It preferably comprises a system whose solvent contains water as its principal constituent, preferably in an amount of at least 20 wt %, and organic solvents in lower fractions, preferably in an amount of <20 wt %, based in each case on the total weight of the effect pigment paste of the invention.

The effect pigment paste of the invention preferably comprises a water fraction of at least 20 wt %, more preferably at least 25 wt %, very preferably of at least 30 wt %, more particularly of at least 35 wt %, most preferably of at least 40 wt %, based in each case on the total weight of the effect pigment paste.

The effect pigment paste of the invention preferably comprises a water fraction which is in a range from 20 to 75 wt %, more preferably in a range from 25 to 70 wt %, very preferably in a range from 30 to 65 wt % or to 60 wt % or to 57.5 wt %, based in each case on the total weight of the effect pigment paste.

The effect pigment paste of the invention preferably comprises an organic solvent fraction which is in a range of <20 wt %, more preferably in a range from 0 to <20 wt %, very preferably in a range of 0.5 to 20 wt % or to 17.5 wt % or to 15 wt %, based in each case on the total weight of the effect pigment paste. The addition of organic solvents is appropriate in particular for effect pigment pastes which comprise aluminum effect pigments as effect pigment (a). The effect pigment pastes of the invention may alternatively be completely or almost completely free of organic solvents, especially if metal oxide-on-mica pigments are used as effect pigment (a). In such a case the organic solvent fraction is preferably less than 10 wt %, more particularly less than 5 wt %, based in each case on the total weight of the effect pigment paste.

The solids content of the effect pigment paste of the invention is preferably in a range from 15 to 65 wt %, more preferably of 17.5 to 60 wt %, especially preferably of 20 to 55 wt %, more particularly of 22.5 to 50 wt %, most preferably of 25 to 45 wt %, based in each case on the total weight of the effect pigment paste. The solids content, i.e., the nonvolatile fraction, is determined in accordance with the invention described hereinafter.

The percentage sum of the solids contents of the effect pigment paste of the invention and the water fraction in the effect pigment paste of the invention is preferably >50 wt %, more preferably at least 55 or at least 60 wt %, very preferably at least 65 or at least 70 wt %, more particularly at least 75 wt %. Preferred in turn are ranges of >50 to 99 wt %, especially 55 or 60 to 97.5 wt %. If, for example, an effect pigment paste of the invention has a solids content of 30 wt % and a water content of 65 wt %, the above-defined percentage sum of the solids content and the water fraction is 95 wt %.

The effect pigment paste of the invention preferably comprises a polymer (b) fraction in a range from 1.0 to 25 wt %, more preferably from 1.5 to 20 wt %, very preferably from 2.0 to 17.5 wt %, more particularly from 2.5 to 15 wt %, most preferably from 4.0 to 12.5 wt %, based in each case on the total weight of the effect pigment paste. The fraction of the polymer (b) in the effect pigment paste may be determined or specified via the determination of the solids content (also called nonvolatile fraction or solids fraction) of an aqueous dispersion comprising the polymer (b) and used in producing the effect pigment paste.

The effect pigment paste of the invention comprises an effect pigment (a) fraction of at least 10 wt %, preferably of at least 11 or 12 wt %, more preferably of at least 13 or 14 wt %, more particularly of at least 15 or 16 or 17 or 18 wt %, most preferably of at least 19 wt %, based in each case on the total weight of the effect pigment paste.

The effect pigment paste of the invention preferably comprises an effect pigment (a) fraction in a range from 10 to 50 wt %, more preferably from 10 to 45 wt %, very preferably from 10 to 40 wt %, more particularly from 11 to 35 wt %, most preferably from 12 to 30 wt % or from 12 to 27.5 wt %, based in each case on the total weight of the effect pigment paste.

The relative weight ratio of the at least one effect pigment (a) to the polymer (b) in the effect pigment paste is preferably at least 1:1 or at least 1.2:1 or at least 1.5:1 or higher in each case, more preferably at least 2.0:1 or higher, very preferably at least 2.5:1 or higher, more particularly at least 3.0:1 or higher.

The relative weight ratio of the at least one effect pigment (a) to the polymer (b) in the effect pigment paste is preferably in a range from 10:1 to 1:1 or from 8:1 to 1:1, more preferably in a range from 10:1 to 1.2:1 or from 10:1 to 1.5:1 or in a range from 8:1 to 1.2:1 or from 8:1 to 1.5:1.

The fractions in weight percent of all of the components present in the effect pigment paste of the invention, vis components (a), (b), and water, and also further components optionally present additionally, add up to 100 wt %, based on the total weight of the effect pigment paste.

Effect Pigment (a)

The effect pigment paste of the invention comprises at least one effect pigment as component (a), preferably in an amount of at least 10 wt %, based on the total weight of the effect pigment paste.

A skilled person is familiar with the concept of the effect pigments. A corresponding definition is found for example in Rompp Lexikon, Lacke and Druckfarben, Georg Thieme Verlag, 1998, 10th edition, pages 176 and 471. A definition of pigments in general, and further particularizations thereof, are governed in DIN 55943 (date: October 2001). Effect pigments are preferably pigments which impart optical effect or both color and optical effect, especially optical effect. The terms “optical effect and color pigment”, “optical effect pigment” and “effect pigment” are therefore preferably interchangeable.

Preferred effect pigments are, for example, platelet-shaped metal effect pigments such as lamellar aluminum pigments, gold bronzes, oxidized bronzes and/or iron oxide-aluminum pigments, pearlescent pigments such as pearl essence, basic lead carbonate, bismuth oxychloride and/or metal oxide-on-mica pigments, and/or other effect pigments such as lamellar graphite, lamellar iron oxide, multilayer effect pigments composed of PVD films, and/or liquid-crystal polymer pigments. Particularly preferred are lamellar effect pigments, especially lamellar aluminum pigments and metal oxide-on-mica pigments, in the pigment paste. As at least one effect pigment (a), therefore, the effect pigment paste of the invention preferably comprises at least one metallic effect pigment such as at least one preferably lamellar aluminum effect pigment and/or at least one metal oxide-on-mica pigment.

The effect pigment paste of the invention may optionally comprise further pigments different from the at least one effect pigment (a), more particularly color pigments and/or fillers. Preferably, however, the effect pigment paste of the invention contains no such further pigment such as a color pigment and also no filler.

Polymer (b)

The effect pigment paste of the invention comprises at least one polymer (b) having an average particle size in the range from 100 to 500 nm, preparable by successive radical emulsion polymerization of three monomer mixtures (A), (B) and (C) of olefinically unsaturated monomers in water, where
the mixture (A) comprises at least 50 wt % of monomers having a solubility in water of less than 0.5 g/l at 25° C., and a polymer prepared from the mixture (A) possesses a glass transition temperature of 10 to 65° C.,
the mixture (B) comprises at least one polyunsaturated monomer, and a polymer prepared from the mixture (B) possesses a glass transition temperature of −35 to 15° C., and
a polymer prepared from the mixture (C) possesses a glass transition temperature of −50 to 15° C., and where
i. first the mixture (A) is polymerized,
ii. then the mixture (B) is polymerized in the presence of the polymer prepared under i., and
iii. thereafter the mixture (C) is polymerized in the presence of the polymer prepared under ii.

The polymers (b) represent what are called seed-core-shell polymers (SCS polymers). Polymers (b) and aqueous dispersions comprising such polymers are known for example from WO 2016/116299 A1. The polymer (b) is preferably a (meth)acrylic copolymer.

The polymer (b) present in the effect pigment paste of the invention is used as a pigment paste binder (paste binder). The term “binder” in the sense of the present invention, in agreement with DIN EN ISO 4618 (German version, date: March 2007), refers preferably to those nonvolatile fractions of a composition that are responsible for film formation, such as of the effect pigment paste of the invention or of the basecoat material of the invention, apart from the pigments present therein, such as the at least one effect pigment (a) and other pigments and/or fillers optionally present. The nonvolatile fraction may be determined by a method described hereinafter. A binder constituent, accordingly, is a particular component which contributes to the binder content of a composition such as the effect pigment paste of the invention or the basecoat material of the invention. An example would be a basecoat material comprising the polymer (b), a crosslinking agent such as a melamine resin and/or a free or blocked polyisocyanate and/or a polymeric additive.

The polymer (b) is used preferably in the form of an aqueous dispersion for producing the effect pigment paste of the invention.

The preparation of the polymer (b) comprises the successive radical emulsion polymerization of three mixtures (A), (B) and (C) of olefinically unsaturated monomers in each case in water. It is therefore a multistage radical emulsion polymerization where i. first the mixture (A) is polymerized, then ii. the mixture (B) is polymerized in the presence of the polymer prepared under i. and, furthermore, iii. the mixture (C) is polymerized in the presence of the polymer prepared under ii. All three monomer mixtures are therefore polymerized by a radical emulsion polymerization (i.e. stage or else polymerization stage), carried out separately in each case, with these stages taking place successively. In terms of time, the stages may take place immediately after one another. It is equally possible, after the end of one stage, for the reaction solution in question to be stored for a certain period and/or transferred to a different reaction vessel, and only then for the next stage to be carried out. The preparation of the polymer (b) preferably comprises no polymerization steps other than the polymerization of the monomer mixtures (A), (B) and (C).

The concept of radical emulsion polymerization is one known to the skilled person, and is elucidated in more detail hereinafter, moreover. In the polymerization, olefinically unsaturated monomers are polymerized in an aqueous medium, preferably with use of at least one water-soluble initiator and in the presence of at least one emulsifier. Corresponding water-soluble initiators are likewise known. The at least one water-soluble initiator is preferably selected from the group consisting of potassium, sodium or ammonium peroxodisulfate, hydrogen peroxide, tert-butyl hydroperoxide, 2,2′-azobis(2-amidoisopropane) dihydrochloride, 2,2′-azobis(N,N′-dimethyleneisobutyramidine) dihydrochloride, 2,2′-azobis(4-cyanopentanoic acid), and mixtures of the aforesaid initiators, such as hydrogen peroxide and sodium persulfate, for example. Likewise members of the preferred group stated are the redox initiator systems, which are known per se. Redox initiator systems are, in particular, those initiators which comprise at least one peroxide-containing compound in combination with at least one redox coinitiator, examples being reductive sulfur compounds such as, for example, bisulfites, sulfites, thiosulfates, dithionites or tetrathionites of alkali metals and ammonium compounds, sodium hydroxymethanesulfinate dihydrate and/or thiourea. Hence it is possible to use combinations of peroxodisulfates with alkali metal hydrogensulfites or ammonium hydrogensulfites, examples being ammonium peroxydisulfate and ammonium disulfite. The weight ratio of peroxide-containing compounds to the redox coinitiators is preferably 50:1 to 0.05:1.

In combination with the initiators it is possible additionally to use transition metal catalysts, such as, for example, iron, nickel, cobalt, manganese, copper, vanadium or chromium salts, such as iron(II) sulfate, cobalt(II) chloride, nickel(II) sulfate, copper(I) chloride, manganese(II) acetate, vanadium(III) acetate, manganese(II) chloride. Based on the total mass of the olefinically unsaturated monomers used in a polymerization, these transition metal salts are employed customarily in amounts of 0.1 to 1000 ppm. Hence it is possible to use combinations of hydrogen peroxide with iron(II) salts, such as, for example, 0.5 to 30 wt % of hydrogen peroxide and 0.1 to 500 ppm of Mohr's salt, the fractional ranges being based in each case on the total weight of the monomers used in the respective polymerization stage. The initiators are used preferably in an amount of 0.05 to 20 wt %, preferably 0.05 to 10, more preferably of 0.1 to 5 wt %, based on the total weight of the monomers used in the respective polymerization stage.

An emulsion polymerization proceeds within a reaction medium that comprises water as continuous medium and, in addition, preferably at least one emulsifier, preferably in the form of micelles. The polymerization is started by decomposition of the water-soluble initiator in the water. The growing polymer chain is incorporated into the emulsifier micelles, and the further polymerization then takes place within the micelles. As well as the monomers, the at least one water-soluble initiator, and the at least one emulsifier, therefore, the reaction mixture consists primarily of water. The stated components—that is, monomers, water-soluble initiator, emulsifier, and water—make up preferably at least 95 wt % of the reaction mixture. The reaction mixture preferably consists of these components. The at least one emulsifier is used preferably in an amount of 0.1-10 wt %, more preferably 0.1-5 wt %, very preferably 0.1-3 wt %, based in each case on the total weight of the monomers used in the respective polymerization stage. Emulsifiers as well are known in principle. Those used may be nonionic or ionic emulsifiers, including zwitterionics, and optionally, also, mixtures of the aforesaid emulsifiers. Preferred emulsifiers are optionally ethoxylated and/or propoxylated alkanols having 10 to 40 carbon atoms. They may have different degrees of ethoxylation and/or propoxylation (examples being adducts modified with poly(oxy)ethylene and/or poly(oxy)propylene chains consisting of 5 to 50 molecular units). Sulfated, sulfonated or phosphated derivatives of the stated products may also be used. Such derivatives are generally employed in neutralized form. Particularly preferred emulsifiers are neutralized dialkylsulfosuccinic esters or alkyldiphenyl oxide disulfonates, suitably, available commercially for example as EF-800 from Cytec. The emulsion polymerizations are carried out judiciously at a temperature of 0 to 160° C., preferably of 15 to 95° C., more preferably 60 to 95° C. This operation takes place preferably in the absence of oxygen, preferably under an inert gas atmosphere. In general the polymerization is carried out at atmospheric pressure, although the use of lower pressures or higher pressures is also possible. Particularly if polymerization temperatures are employed that lie above the boiling point of water, the monomers used and/or the organic solvents under atmospheric pressure, higher pressures are generally selected.

The individual polymerization stages in the preparation of the polymer (b) may be carried out, for example, as what are called “starved feed” polymerizations (also known as “starve feed” or “starve fed” polymerizations). A starved feed polymerization in the sense of the present invention is an emulsion polymerization in which the amount of free olefinically unsaturated monomers in the reaction solution (also called reaction mixture) is minimized throughout the reaction time. This means that the metered addition of the olefinically unsaturated monomers is such that over the entire reaction time the fraction of free monomers in the reaction solution does not exceed 6.0 wt %, preferably 5.0 wt %, more preferably 4.0 wt %, particularly advantageously 3.5 wt %, based in each case on the total amount of the monomers used in the respective polymerization stage. Further preferred within these strictures are concentration ranges for the olefinically unsaturated monomers of 0.01 to 6.0 wt %, preferably 0.02 to 5.0 wt %, more preferably 0.03 to 4.0 wt %, more particularly 0.05 to 3.5 wt %. For example, the highest weight fraction detectable during the reaction may be 0.5 wt %, 1.0 wt %, 1.5 wt %, 2.0 wt %, 2.5 wt % or 3.0 wt %, while all other values detected then lie below the values indicated here. The total amount (also called total weight) of the monomers used in the respective polymerization stage evidently corresponds for stage i. to the total amount of the monomer mixture (A), for stage ii. to the total amount of the monomer mixture (B), and for stage iii. to the total amount of the monomer mixture (C). The concentration of the monomers in the reaction solution here may be determined by gas chromatography, for example. In that case a sample of the reaction solution is cooled with liquid nitrogen immediately after sampling, and 4-methoxyphenol is added as an inhibitor. In the next step, the sample is dissolved in tetrahydrofuran and then n-pentane is added in order to precipitate the polymer formed at the time of sampling. The liquid phase (supernatant) is then analyzed by gas chromatography, using a polar column and an apolar column for determining the monomers, and using a flame ionization detector. Typical parameters for the gas-chromatographic determination are as follows: 25 m silica capillary column with 5% phenyl-, 1% vinyl-methylpolysiloxane phase or 30 m silica capillary column with 50% phenol- and 50% methyl-polysiloxane phase, carrier gas hydrogen, split injector 150° C., oven temperature 50 to 180° C., flame ionization detector, detector temperature 275° C., internal standard isobutyl acrylate. The concentration of the monomers for the purposes of the present invention is determined preferably by gas chromatography, more particularly in compliance with the parameters specified above.

The fraction of the free monomers may be controlled in various ways. One possibility for keeping the fraction of the free monomers low is to select a very low metering rate for the mixture of the olefinically unsaturated monomers into the actual reaction solution, in which the monomers make contact with the initiator. If the metering rate is so low that all of the monomers are able to react virtually immediately when they are in the reaction solution, it is possible to ensure that the fraction of the free monomers is minimized. In addition to the metering rate, it is important that there are always sufficient radicals present in the reaction solution to allow each of the added monomers to react extremely quickly. In this way, further chain growth of the polymer is guaranteed, and the fraction of free monomer is kept low. For this purpose, the reaction conditions are preferably selected such that the initiator feed is commenced even before the start of the metering of the olefinically unsaturated monomers. The metering is preferably commenced at least 5 minutes beforehand, more preferably at least 10 minutes beforehand. With preference at least 10 wt % of the initiator, more preferably at least 20 wt %, very preferably at least 30 wt % of the initiator, based in each case on the total amount of initiator, is added before the metering of the olefinically unsaturated monomers is commenced. Preference is given to selecting a temperature which allows constant decomposition of the initiator. The amount of initiator is likewise an important factor in the sufficient presence of radicals in the reaction solution. The amount of initiator should be selected such that at any time there are sufficient radicals available to allow the added monomers to react. If the amount of initiator is increased, greater amounts of monomers can be reacted at the same time.

A further factor determining the reaction rate is the reactivity of the monomers. Control over the fraction of the free monomers may therefore be guided by the interplay of initiator quantity, rate of initiator addition, rate of monomer addition, and through selection of the monomers. Not only a slowing-down of metering but also an increase in the initiator quantity, and also the premature commencement of addition of the initiator, serve the aim of keeping the concentration of free monomers below the limits stated above. At any point during the reaction, the concentration of free monomers can be determined by gas chromatography, as described above. Should this analysis find a concentration of free monomers that comes close to the limiting value for the starved feed polymerization, as a result, for example, of small fractions of highly reactive olefinically unsaturated monomers, the parameters referred to above can be utilized in order to control the reaction. In this case, for example, the metering rate of the monomers can be lowered, or the amount of initiator can be increased.

For the purposes of the present invention it is preferable for at least the polymerization stages ii. and iii. to be carried out under starved feed conditions. This has the advantage that the formation of new particle nuclei within these two polymerization stages is effectively minimized. Instead, the particles existing after stage i. (and therefore also called seed below) can be grown further in stage ii. by the polymerization of the monomer mixture B (therefore also called core below). It is likewise possible for the particles existing after stage ii. (also below called polymer comprising seed and core) to be grown further in stage iii. through the polymerization of the monomer mixture C (therefore also called shell below), resulting ultimately in a polymer (b) comprising particles containing seed, core, and shell (also referred to as SCS polymer). Stage i. as well may of course be carried out under starved feed conditions.

The mixtures (A), (B), and (C) are mixtures of olefinically unsaturated monomers. Suitable olefinically unsaturated monomers may be mono- or polyolefinically unsaturated. Described first of all below are monomers which can be used in principle and which are suitable across all mixtures (A), (B), and (C), and monomers that are optionally preferred. Specific preferred embodiments of the individual mixtures are addressed thereafter.

Examples of suitable monoolefinically unsaturated monomers include, in particular, (meth)acrylate-based monoolefinically unsaturated monomers, monoolefinically unsaturated monomers containing allyl groups, and other monoolefinically unsaturated monomers containing vinyl groups, such as vinylaromatic monomers, for example.

The term (meth)acrylic or (meth)acrylate for the purposes of the present invention encompasses both methacrylates and acrylates. Preferred for use at any rate, although not necessarily exclusively, are (meth)acrylate-based monoolefinically unsaturated monomers.

The (meth)acrylate-based monoolefinically unsaturated monomers may be, for example, (meth)acrylic acid and esters, nitriles, or amides of (meth)acrylic acid.

Preference is given to esters of (meth)acrylic acid having a non-olefinically unsaturated radical R.

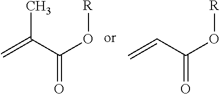

The radical R may be saturated aliphatic, aromatic, or mixed saturated aliphatic-aromatic. Aliphatic radicals for the purposes of the present invention are all organic radicals which are not aromatic. Preferably the radical R is aliphatic. The saturated aliphatic radical may be a pure hydrocarbon radical or it may include heteroatoms from bridging groups (for example, oxygen from ether groups or ester groups) and/or may be substituted by functional groups containing heteroatoms (alcohol groups, for example). For the purposes of the present invention, therefore, a clear distinction is made between bridging groups containing heteroatoms and functional groups containing heteroatoms (that is, terminal functional groups containing heteroatoms).

Preference is given at any rate, though not necessarily exclusively, to using monomers in which the saturated aliphatic radical R is a pure hydrocarbon radical (alkyl radical), in other words one which does not include any heteroatoms from bridging groups (oxygen from ether groups, for example) and is also not substituted by functional groups (alcohol groups, for example). If R is an alkyl radical, it may for example be a linear, branched, or cyclic alkyl radical. Such an alkyl radical may of course also have linear and cyclic or branched and cyclic structural components. The alkyl radical preferably has 1 to 20, more preferably 1 to 10, carbon atoms.

Particularly preferred monounsaturated esters of (meth)acrylic acid with an alkyl radical are methyl (meth)acrylate, ethyl (meth)acrylate, propyl (meth)-acrylate, isopropyl (meth)acrylate, n-butyl (meth)acrylate, isobutyl (meth)acrylate, tert-butyl (meth)acrylate, amyl (meth)acrylate, hexyl (meth)acrylate, ethylhexyl (meth)acrylate, 3,3,5-trimethylhexyl (meth)acrylate, stearyl (meth)acrylate, lauryl (meth)acrylate, cycloalkyl (meth)acrylates, such as cyclopentyl (meth)acrylate, isobornyl (meth)acrylate, and also cyclohexyl (meth)acrylate, with very particular preference being given to n- and tert-butyl (meth)acrylate and to methyl methacrylate.

Examples of other suitable radicals R are saturated aliphatic radicals which comprise functional groups containing heteroatoms (for example, alcohol groups or phosphoric ester groups). Suitable monounsaturated esters of (meth)acrylic acid with a saturated aliphatic radical substituted by one or more hydroxyl groups are 2-hydroxyethyl (meth)acrylate, 2-hydroxypropyl (meth)acrylate, 3-hydroxypropyl (meth)acrylate, 3-hydroxybutyl (meth)acrylate, and 4-hydroxybutyl (meth)acrylate, with very particular preference being given to 2-hydroxyethyl (meth)acrylate. Suitable monounsaturated esters of (meth)acrylic acid with phosphoric ester groups are, for example, phosphoric esters of polypropylene glycol monomethacrylate, such as the commercially available Sipomer PAM 200 from Rhodia. Possible further monoolefinically unsaturated monomers containing vinyl groups are monomers which are different from the above-described acrylate-based monomers and which have a radical R′ on the vinyl group that is not olefinically unsaturated:

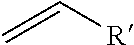

The radical R′ may be saturated aliphatic, aromatic, or mixed saturated aliphatic-aromatic, with preference being given to aromatic and mixed saturated aliphatic-aromatic radicals in which the aliphatic components represent alkyl groups.

Particularly preferred further monoolefinically unsaturated monomers containing vinyl groups are, in particular, vinyltoluene, alpha-methylstyrene, and especially styrene.

Also possible are monounsaturated monomers containing vinyl groups, wherein the radical R′ has the following structure:

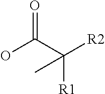

where the radicals R1 and R2 are alkyl radicals which each or together contain a total of 7 carbon atoms. Monomers of this kind are available commercially under the name VeoVa® 10 from Momentive.

Further monomers suitable in principle are olefinically unsaturated monomers such as acrylonitrile, methacrylo-nitrile, acrylamide, methacrylamide, N-dimethylacryl-amide, vinyl acetate, vinyl propionate, vinyl chloride, N-vinylpyrrolidone, N-vinylcaprolactam, N-vinylform-amide, N-vinylimidazole, N-vinyl-2-methylimidazoline, and further unsaturated alpha-beta-carboxylic acids.

Examples of suitable polyolefinically unsaturated monomers include esters of (meth)acrylic acid with an olefinically unsaturated radical R″. The radical R″ may be, for example, an allyl radical or a (meth)acryloyl radical:

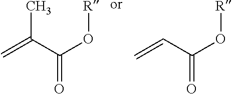

Preferred polyolefinically unsaturated monomers include ethylene glycol di(meth)acrylate, 1,2-propylene glycol di(meth)acrylate, 2,2-propylene glycol di(meth)acrylate, butane-1,4-diol di(meth)acrylate, neopentyl glycol di(meth)acrylate, 3-methylpentanediol di(meth)acrylate, diethylene glycol di(meth)acrylate, triethylene glycol di(meth)acrylate, tetraethylene glycol di(meth)acrylate, dipropylene glycol di(meth)acrylate, tripropylene glycol di(meth)acrylate, hexanediol di(meth)acrylate, and allyl (meth)acrylate.

Furthermore, preferred polyolefinically unsaturated compounds encompass acrylic and methacrylic esters of alcohols having more than two OH groups, such as, for example, trimethylolpropane tri(meth)acrylate or glycerol tri(meth)acrylate, but also trimethylolpropane di(meth)acrylate monoallyl ether, trimethylolpropane (meth)acrylate diallyl ether, pentaerythritol tri(meth)acrylate monoallyl ether, pentaerythritol di(meth)acrylate diallyl ether, pentaerythritol (meth)acrylate triallyl ether, triallylsucrose, and pentaallylsucrose. Also possible are allyl ethers of mono- or polyhydric alcohols, such as trimethylolpropane monoallyl ether, for example. Where used, preferred polyolefinically unsaturated monomers are hexanediol diacrylate and/or allyl (meth)acrylate.

With regard to the monomer mixtures (A), (B), and (C) used in the individual polymerization stages, there are preferably specific conditions to be observed, which are set out below. First of all it should be stated that the mixtures (A), (B), and (C) are at any rate different from one another. They therefore each contain different monomers and/or different proportions of at least one defined monomer.

Mixture (A)

Mixture (A) comprises at least 50 wt %, preferably at least 55 wt %, of olefinically unsaturated monomers having a water solubility of less than 0.5 g/l at 25° C. One such preferred monomer is styrene. The solubility of the monomers in water is determined by the method described hereinafter.

The monomer mixture (A) preferably contains no hydroxy-functional monomers. Likewise preferably, the monomer mixture (A) contains no acid-functional monomers. Very preferably the monomer mixture (A) contains no monomers at all that have functional groups containing heteroatoms. This means that heteroatoms, if present, are present only in the form of bridging groups. This is the case, for example, in the monoolefinically unsaturated monomers described above that are (meth)acrylate-based and possess an alkyl radical as radical R.

The monomer mixture (A) preferably comprises exclusively monoolefinically unsaturated monomers.

The monomer mixture (A) preferably comprises at least one monounsaturated ester of (meth)acrylic acid with an alkyl radical and at least one monoolefinically unsaturated monomer containing vinyl groups, with a radical arranged on the vinyl group that is aromatic or that is mixed saturated aliphatic-aromatic, in which case the aliphatic fractions of the radical are alkyl groups.

The monomers present in the mixture (A) are selected such that a polymer prepared from them possesses a glass transition temperature of 10 to 65° C., preferably of 30 to 50° C. The glass transition temperature here can be determined by the method described hereinafter.

The polymer prepared in stage i. by the emulsion polymerization of the monomer mixture (A) is also called seed. The seed possesses preferably an average particle size of 20 to 125 nm (measured by dynamic light scattering as described hereinafter; cf. Determination method 4.).

Mixture (B)

Mixture (B) comprises at least one polyolefinically unsaturated monomer, more preferably at least one diolefinically unsaturated monomer. One such preferred monomer is hexanediol diacrylate. The monomer mixture (B) preferably contains no hydroxy-functional monomers. Likewise preferably, the monomer mixture (B) contains no acid-functional monomers. Very preferably the monomer mixture (B) contains no monomers at all with functional groups containing heteroatoms. This means that heteroatoms, if present, are present only in the form of bridging groups. This is the case, for example, in the above-described monoolefinically unsaturated monomers which are (meth)acrylate-based and possess an alkyl radical as radical R.

Preferably, the monomer mixture (B), as well as the at least one polyolefinically unsaturated monomer, includes at any rate the following further monomers: First of all, at least one monounsaturated ester of (meth)acrylic acid with an alkyl radical, and secondly at least one monoolefinically unsaturated monomer containing vinyl groups and having a radical located on the vinyl group that is aromatic or that is a mixed saturated aliphatic-aromatic radical, in which case the aliphatic fractions of the radical are alkyl groups.

The fraction of polyunsaturated monomers is preferably from 0.05 to 3 mol %, based on the total molar amount of monomers in the monomer mixture (B).

The monomers present in the mixture (B) are selected such that a polymer prepared therefrom possesses a glass transition temperature of −35 to 15° C., preferably of −25 to +7° C. The glass transition temperature here can be determined by the method described hereinafter.

The polymer prepared in the presence of the seed in stage ii. by the emulsion polymerization of the monomer mixture (B) is also referred to as the core. After stage ii., then, the result is a polymer which comprises seed and core. The polymer which is obtained after stage ii. preferably possesses an average particle size of 80 to 280 nm, preferably 120 to 250 nm (measured by dynamic light scattering as described hereinafter; cf. Determination method 4.).

Mixture (C)

The monomers present in the mixture (C) are selected such that a polymer prepared therefrom possesses a glass transition temperature of −50 to 15° C., preferably of −20 to +12° C. The glass transition temperature here can be determined by the method described hereinafter.

The olefinically unsaturated monomers of this mixture (C) are preferably selected such that the resulting polymer, comprising seed, core, and shell, has an acid number of 10 to 25. Accordingly, the mixture (C) preferably comprises at least one alpha-beta unsaturated carboxylic acid, especially preferably (meth)acrylic acid. The olefinically unsaturated monomers of the mixture (C) are further or alternatively preferably selected such that the resulting polymer, comprising seed, core, and shell, has an OH number of 0 to 30, preferably 10 to 25. All of the aforementioned acid numbers and OH numbers are values calculated on the basis of the monomer mixtures employed overall.

The monomer mixture (C) preferably comprises at least one alpha-beta unsaturated carboxylic acid and at least one monounsaturated ester of (meth)acrylic acid having an alkyl radical substituted by a hydroxyl group. More preferably, the monomer mixture (C) comprises at least one alpha-beta unsaturated carboxylic acid, at least one monounsaturated ester of (meth)acrylic acid having an alkyl radical substituted by a hydroxyl group, and at least one monounsaturated ester of (meth)acrylic acid having an alkyl radical. Where reference is made, in the context of the present invention, to an alkyl radical, without further particularization, what is always meant by this is a pure alkyl radical without functional groups and heteroatoms.

The polymer prepared in the presence of seed and core in stage iii. by the emulsion polymerization of the monomer mixture (C) is also referred to as the shell. The result after stage iii., then, is a polymer which comprises seed, core, and shell, i.e., polymer (b). Following its preparation, the polymer (b) possesses an average particle size of 100 to 500 nm, preferably 125 to 400 nm, very preferably from 130 to 300 nm (measured by dynamic light scattering as described hereinafter; cf. Determination method 4.).

The fractions of the monomer mixtures are preferably harmonized with one another as follows: The fraction of the mixture (A) is from 0.1 to 10 wt %, the fraction of the mixture (B) is from 60 to 80 wt %, and the fraction of the mixture (C) is from 10 to 30 wt %, based in each case on the sum of the individual amounts of the mixtures (A), (B), and (C).

As already noted above, the polymer (b) is used preferably in the form of an aqueous dispersion for producing the effect pigment paste of the invention. This aqueous dispersion preferably possesses a pH of 5.0 to 9.0, more preferably 7.0 to 8.5, very preferably 7.5 to 8.5. The pH may be kept constant during the preparation itself, through the use of bases as identified further on below, for example, or else may be set deliberately after the polymer has been prepared. In especially preferred embodiments it is the case that this aqueous dispersion has a pH of 5.0 to 9.0 and the at least one polymer (b) present therein has a particle size of 100 to 500 nm. Even more preferred range combinations are as follows: pH of 7.0 to 8.5 and a particle size of 125 to 400 nm, more preferably pH of 7.5 to 8.5 and a particle size of 130 to 300 nm.

The stages i. to iii. described are carried out preferably without addition of acids or bases known for the setting of the pH. If in the preparation of the polymer (b), for example, carboxy-functional monomers are then used, as is preferred in the context of stage iii., the pH of the dispersion may be less than 7 after the end of stage iii. Accordingly, an addition of base may be needed in order to adjust the pH to a higher value, such as, for example, a value within the preferred ranges. It follows from the above that the pH in this case preferably after stage iii. is correspondingly adjusted or has to be adjusted, in particular through addition of a base such as an organic, nitrogen-containing base, such as an amine such as ammonia, trimethylamine, triethylamine, tributylamines, dimethylaniline, triphenylamine, N,N-dimethylethanolamine, methyldiethanolamine, or triethanolamine, and also by addition of sodium hydrogencarbonate or borates, and also mixtures of the aforesaid substances. This, however, does not rule out the possibility of adjusting the pH before, during, or after the emulsion polymerizations or else between the individual emulsion polymerizations. It is likewise possible for there to be no need at all for the pH to be adjusted to a desired value, owing to the choice of the monomers. The measurement of the pH here is carried out preferably using a pH meter (for example, Mettler-Toledo S20 SevenEasy pH meter) having a combined pH electrode (for example, Mettler-Toledo InLab® Routine).

If the polymer (b) is used in the form an aqueous dispersion for producing the effect pigment paste of the invention, the nonvolatile fraction is preferably in the range from 15 to 40 wt %, more preferably in the range from 20 to 30 wt %, based in each case on the total weight of the aqueous dispersion. The nonvolatile fraction here is determined by the method described hereinafter. The aqueous dispersion used preferably comprises a water fraction of 55 to 75 wt %, especially preferably of 60 to 70 wt %, based in each case on the total weight of the dispersion. The percentage sum of the solids content of the dispersion and the water fraction in the dispersion is preferably at least 80 wt %, preferably at least 90 wt %. Preferred in turn are ranges from 80 to 99 wt %, more particularly 90 to 97.5 wt %. Accordingly, the aqueous dispersion used consists very largely of water and the polymer (b), and comprises only minor fractions, or none, of environmentally burdensome components such as, in particular, organic solvents.

Further Optional Components of the Effect Pigment Paste of the Invention

The effect pigment paste of the invention may comprise further, optional constituents and optional components:

Besides the at least one effect pigment (a), the effect pigment paste may further comprise typical color pigments, which are different from the effect pigment (a). A skilled person is familiar with the concept of color pigments. The terms “coloring pigment” and “color pigment” are interchangeable. Color pigments used can be organic and/or inorganic pigments. The color pigment is preferably an inorganic color pigment. Particularly preferred color pigments used are white pigments, chromatic pigments and/or black pigments. Examples of white pigments are titanium dioxide, zinc white, zinc sulfide, and lithopone. Examples of black pigments are carbon black, iron manganese black, and spinel black. Examples of chromatic pigments are chromium oxide, chromium oxide hydrate green, cobalt green, ultramarine green, cobalt blue, ultramarine blue, manganese blue, ultramarine violet, cobalt violet and manganese violet, red iron oxide, cadmium sulfoselenide, molybdate red and ultramarine red, brown iron oxide, mixed brown, spinel phases and corundum phases, and chromium orange, yellow iron oxide, nickel titanium yellow, chromium titanium yellow, cadmium sulfide, cadmium zinc sulfide, chromium yellow, and bismuth vanadate. The fraction of the color pigments is situated preferably in the range from 1.0 to 40.0 wt %, preferably 2.0 to 35.0 wt %, more preferably 5.0 to 30.0 wt %, based in each case on the total weight of the aqueous effect pigment paste. Preferably, however, the effect pigment paste of the invention comprises the at least one effect pigment (a) as sole pigment, meaning that it preferably contains no additional color pigments. Preferably, furthermore, the effect pigment paste of the invention contains no fillers.

The effect pigment paste may optionally further comprise at least one thickener (also called thickening agent). Examples of such thickeners are inorganic thickeners, examples being metal silicates such as phyllosilicates, and organic thickeners, examples being poly(meth)acrylic acid thickeners and/or (meth)acrylic acid-(meth)acrylate copolymer thickeners, polyurethane thickeners, and polymeric waxes. The metal silicate is preferably selected from the group of the smectites. With particular preference the smectites are selected from the group of the montmorillonites and hectorites. More particularly the montmorillonites and hectorites are selected from the group consisting of aluminum magnesium silicates and also sodium magnesium phyllosilicates and sodium magnesium fluorine lithium phyllosilicates. These inorganic phyllosilicates are sold for example under the brand name Laponite®. Thickening agents based on poly(meth)acrylic acid, and (meth)acrylic acid-(meth)acrylate copolymer thickeners are optionally crosslinked and/or neutralized with a suitable base. Examples of such thickening agents are Alkali Swellable Emulsions (ASE), and hydrophobically modified variants thereof, the “Hydrophilically modified Alkali Swellable Emulsions” (HASE). These thickening agents are preferably anionic. Corresponding products such as Rheovis® AS 1130 are available commercially. Thickening agents based on polyurethanes (e.g., polyurethane associative thickening agents) are optionally crosslinked and/or neutralized with a suitable base. Corresponding products such as Rheovis® PU 1250 are available commercially. Examples of suitable polymeric waxes include optionally modified polymeric waxes based on ethylene-vinyl acetate copolymers. One such product is available commercially, for example, under the Aquatix® 8421 designation. The at least one thickener is preferably present in the effect pigment paste of the invention in an amount of at most 10 wt %, more preferably of at most 7.5 wt %, very preferably of at most 5 wt %, more particularly of at most 3 wt %, most preferably of at most 2 wt %, based in each case on the total weight of the effect pigment paste.

Depending on desired application, the effect pigment paste of the invention may comprise one or more customarily employed additives as (a) further component(s). For example, as already noted above, the effect pigment paste may include a certain fraction of at least one organic solvent. Further, the effect pigment paste may comprise at least one additive selected from the group consisting of reactive diluents, fillers, light stabilizers, antioxidants, deaerating agents, emulsifiers, slip additives, polymerization inhibitors, initiators of radical polymerizations, adhesion promoters, flow control agents, film-forming auxiliaries, sag control agents (SCAs), flame retardants, corrosion inhibitors, siccatives, biocides, and matting agents. They may be used in the known and customary fractions. The amount thereof, based on the total weight of the effect pigment paste of the invention, is preferably 0.01 to 20.0 wt %, more preferably 0.05 to 15.0 wt %, very preferably 0.1 to 10.0 wt %, especially preferably 0.1 to 7.5 wt %, more particularly 0.1 to 5.0 wt %, and most preferably 0.1 to 2.5 wt %.

The effect pigment paste of the invention can be produced using the mixing assemblies and mixing methods that are customary and known for the production of pigment pastes.

Basecoat Material of the Invention

The effect pigment paste of the invention is suitable for producing an aqueous basecoat material. A further subject of the present invention is therefore an aqueous basecoat material, wherein the basecoat material is preparable by admixing at least one effect pigment paste of the invention as component (1) to at least one aqueous component (2) which is suitable for preparing a basecoat material and which comprises at least one polymer which can be used as binder, this polymer which can be used as binder comprising the polymer (b) also present in the effect pigment paste, and/or comprising at least one polymer different therefrom.

The fractions in wt % of all the components (1), (2) and water that are present in the basecoat material of the invention, and also of any further components additionally present, add up to 100 wt %, based on the total weight of the basecoat material.

All preferred embodiments described hereinabove in connection with the effect pigment paste of the invention are also preferred embodiments with regard to the use of this effect pigment paste for producing the basecoat material of the invention, especially in connection with components (a) and (b) of the effect pigment paste.

The concept of the basecoat material is known to a skilled person and defined for example in Rompp Lexikon, Lacke and Druckfarben, Georg Thieme Verlag, 1998, 10th edition, page 57. A basecoat, accordingly, is more particularly a color-imparting, and/or color-imparting and optical-effect-imparting, intermediate coating material that is used in automotive finishing and general industrial coating. It is applied generally to a metallic or plastics substrate which has been pretreated with surfacer or primer-surfacer, and occasionally is also applied directly to the plastics substrate. Old finishes as well, which may have to be further pretreated (by sanding down, for example) may serve as substrates. It is now entirely customary for more than one basecoat film to be applied. In one such case, accordingly, a first basecoat film represents the substrate for a second. In order to protect a basecoat film against environmental effects in particular, at least one additional clearcoat film is applied to it.

The component (2) used for producing the basecoat material of the invention comprises at least one polymer which can be employed as binder, and this polymer which can be employed as binder comprises the polymer (b) present in the effect pigment paste, and/or at least one polymer different therefrom. Preferably the polymer which can be employed as binder and which is present in component (2) comprises the polymer (b) which is also present in the effect pigment paste.

As a result of the use of the effect pigment paste of the invention in its production, the basecoat material comprises at least one polymer (b). The at least one polymer (b) is preferably the principal binder of the basecoat material. Principal binder is a term used for a binder constituent in the context of the present invention preferably when there is no other binder constituent in the coating composition, such as the basecoat material, that is present in a greater fraction, based on the total weight of the respective coating composition. The concept of binder has already been defined above with reference to DIN EN ISO 4618 (German version, date: March 2007).

The basecoat material of the invention is aqueous. It preferably comprises a system whose principal solvent is water, preferably in an amount of at least 20 wt %, and comprises organic solvents in lower fractions, preferably in an amount of <20 wt %, based in each case on the total weight of the basecoat material of the invention.

The basecoat material of the invention preferably comprises a water fraction of at least 20 wt %, more preferably of at least 25 wt %, very preferably of at least 30 wt %, more particularly of at least 35 wt %, based in each case on the total weight of the basecoat material.

The basecoat material of the invention preferably comprises a water fraction which is in a range from 20 to 65 wt %, more preferably in a range from 25 to 60 wt %, very preferably in a range from 30 to 55 wt %, based in each case on the total weight of the basecoat material.

The basecoat material of the invention preferably comprises an organic solvent fraction which is in a range of <20 wt %, more preferably in a range from 0 to <20 wt %, very preferably in a range from 0.5 to <20 wt % or to 15 wt %, based in each case on the total weight of the basecoat material.

The solids content of the basecoat material of the invention is preferably in a range from 10 to 45 wt %, more preferably from 11 to 42.5 wt %, very preferably from 12 to 40 wt %, more particularly from 13 to 37.5 wt %, based in each case on the total weight of the basecoat material. The solids content, i.e., the nonvolatile fraction, is determined in accordance with the method described hereinafter.

The percentage sum of the solids contents of the basecoat material of the invention and the water fraction in the basecoat material of the invention is preferably at least 40 wt %, more preferably at least 50 wt %. Preferred in turn are ranges from 40 to 95 wt %, more particularly 45 or 50 to 90 wt %. If, for example, a basecoat material of the invention has a solids content of 18 wt % and a water content of 25 wt %, the above-defined percentage sum of the solids content and the water fraction is 43 wt %.

The basecoat of the invention preferably comprises a polymer (b) fraction in a range from 1.0 to 20 wt %, more preferably from 1.5 to 19 wt %, very preferably from 2.0 to 18.0 wt %, more particularly from 2.5 to 17.5 wt %, most preferably from 3.0 to 15.0 wt %, based in each case on the total weight of the basecoat material. The fraction of the polymer (b) in the basecoat material may be determined or specified via the determination of the solids content (also called nonvolatile fraction or solids fraction) of an aqueous dispersion comprising the polymer (b) and used for producing not only the effect pigment paste (component 1) but also, optionally, for preparing the component (2).

The basecoat of the invention preferably comprises an effect pigment (a) fraction in a range from 1 to 20 wt %, more preferably from 1.5 to 18 wt %, very preferably from 2 to 16 wt %, more particularly from 2.5 to 15 wt %, most preferably from 3 to 12 wt % or from 3 to 10 wt %, based in each case on the total weight of the basecoat material.

The relative weight ratio of the at least one effect pigment (a) to the polymer (b) in the basecoat material is preferably in a range from 4:1 to 1:4, more preferably in a range from 2:1 to 1:4, very particularly in a range from 2:1 to 1:3, more particularly in a range from 1:1 to 1:3 or from 1:1 to 1:2.5.

The aqueous basecoat material of the invention produced using the effect pigment paste of the invention preferably comprises an aqueous dispersion of the polymer (b) which is incorporated into the basecoat material at least by admixing the effect pigment paste. The polymer (b) has already been described above. The aqueous basecoat material of the invention at least comprises, at least through the use of the effect pigment paste of the invention in its production, at least one effect pigment, namely at least one effect pigment (a). Corresponding effect pigments (a) have already been described above. Additionally, the aqueous basecoat material of the invention may comprise further pigments different from the effect pigment (a), namely color pigments. Corresponding pigments have likewise already been described above. These pigments are preferably present in the component (2) which is used for producing the basecoat material. The total fraction of all pigments in the basecoat material is preferably in the range from 0.5 to 40.0 wt %, more preferably from 2.0 to 20.0 wt %, very preferably from 3.0 to 15.0 wt %, based in each case on the total weight of the basecoat material.

The aqueous basecoat material of the invention preferably further comprises at least one polymer different from the polymer (b), as binder, more particularly at least one polymer selected from the group consisting of polyurethanes, polyureas, polyesters, poly(meth)acrylates and/or copolymers of the stated polymers, more particularly polyurethane-poly(meth)acrylates and/or polyurethane-polyureas. This polymer different from the polymer (b) is present preferably in the component (2) used for producing the basecoat material. It is possible here for component (2) to contain no polymer (b), but instead to include at least one polymer selected from the group consisting of polyurethanes, polyureas, polyesters, poly(meth)acrylates and/or copolymers of the stated polymers, more particularly polyurethane-poly(meth)acrylates and/or polyurethane-polyureas.

Preferred polyurethanes are described for example in German patent application DE 199 48 004 A1, page 4, line 19 to page 11, line 29 (Polyurethane prepolymer B1), in European patent application EP 0 228 003 A1, page 3, line 24 to page 5, line 40, in European patent application EP 0 634 431 A1, page 3, line 38 to page 8, line 9, and in international patent application WO 92/15405, page 2, line 35 to page 10, line 32.

Preferred polyesters are described for example in DE 4009858 A1 in column 6, line 53 to column 7, line 61 and column 10, line 24 to column 13, line 3, or WO 2014/033135 A2, page 2, line 24 to page 7, line 10 and also page 28, line 13 to page 29, line 13.

Preferred polyurethane poly(meth)acrylate copolymers ((meth)acrylated polyurethanes) and their preparation are described for example in WO 91/15528 A1, page 3, line 21 to page 20, line 33, and also in DE 4437535 A1, page 2, line 27 to page 6, line 22.

Preferred polyurethane-polyurea copolymers are polyurethane-polyurea particles, preferably those having an average particle size of 40 to 2000 nm, with the polyurethane-polyurea particles, in each case in reacted form, comprising at least one isocyanate-group-containing polyurethane prepolymer containing anionic groups and/or groups which can be converted into anionic groups, and also at least one polyamine containing two primary amino groups and one or two secondary amino groups. Such copolymers are used preferably in the form of an aqueous dispersion. Polymers of this kind are preparable in principle by conventional polyaddition of, for example, polyisocyanates with polyols and also polyamines. The average particle size of such polyurethane-polyurea particles is determined as described hereinafter (measured by dynamic light scattering as described hereinafter; cf. Determination method 4.).

The fraction of such polymers different from the polymer (b) in the basecoat material is preferably less than the fraction of the polymer (b) in the basecoat material. The polymers described are preferably hydroxy-functional and especially preferably possess an OH number in the range from 15 to 200 mg KOH/g, more preferably from 20 to 150 mg KOH/g.

With particular preference the basecoat materials comprise at least one hydroxy-functional polyurethane-poly(meth)acrylate copolymer, more preferably at least one hydroxy-functional polyurethane-poly(meth)acrylate copolymer and also at least one hydroxy-functional polyester and also, optionally, a preferably hydroxy-functional polyurethane-polyurea copolymer.

The fraction of the further polymers as binders may vary widely and is situated preferably in the range from 1.0 to 25.0 wt %, more preferably 3.0 to 20.0 wt %, very preferably 5.0 to 15.0 wt %, based in each case on the total weight of the basecoat material.

The basecoat material of the invention may further comprise at least one typical crosslinking agent known per se. If it does include a crosslinking agent, that agent is preferably at least one amino resin and/or at least one blocked or free polyisocyanate, preferably an amino resin. Among the amino resins, melamine resins are especially preferred. If the basecoat material does contain crosslinking agent, the fraction of these crosslinking agents, especially amino resins and/or blocked or free polyisocyanates, very preferably amino resins, and preferably in turn melamine resins, is situated preferably in the range from 0.5 to 20.0 wt %, more preferably 1.0 to 15.0 wt %, very preferably 1.5 to 10.0 wt %, based in each case on the total weight of the basecoat material. The fraction of crosslinking agent is preferably smaller than the fraction of the polymer (b) in the basecoat material.

Further Optional Components of the Basecoat Material of the Invention

The basecoat material of the invention may comprise further optional constituents or optional components.

These are the same further constituents identified above in connection with the effect pigment paste of the invention, such as color pigments, fillers, thickeners, organic solvents, and the further additives specified above.

The fraction of the color pigments is preferably in the range from 1.0 to 40.0 wt %, more preferably 2.0 to 35.0 wt %, very preferably 5.0 to 30.0 wt %, based in each case on the total weight of the aqueous basecoat material. The at least one thickener is present in the basecoat material of the invention preferably in an amount of at most 10 wt %, more preferably of at most 7.5 wt %, very preferably of at most 5 wt %, more particularly of at most 3 wt %, most preferably of at most 2 wt %, based in each case on the total weight of the basecoat material. The amount of the at least one further additive, based on the total weight of the basecoat material of the invention, is preferably 0.01 to 20.0 wt %, more preferably 0.05 to 15.0 wt %, very preferably 0.1 to 10.0 wt %, especially preferably 0.1 to 7.5 wt %, more particularly 0.1 to 5.0 wt %, and most preferably 0.1 to 2.5 wt %.

The basecoat material of the invention may be produced using the mixing assemblies and mixing methods customary and known for the production of basecoat materials, but using the effect pigment paste of the invention as admixture component (component (1)).

Use of the Polymer (b) for Dispersing Effect Pigments within an Aqueous Effect Pigment Paste

The polymer (b) is suitable for dispersing effect pigments within an aqueous effect pigment paste. A further subject of the present invention is a use of the polymer (b) identified in connection with the first subject of the present invention for dispersing effect pigments within an aqueous effect pigment paste, preferably in a paste comprising said pigments in an amount of at least 10 wt %, based on the total weight of the effect pigment paste.

All preferred embodiments described hereinabove in connection with the effect pigment paste of the invention and the basecoat material of the invention are also preferred embodiments in relation to the use of the polymer (b) for dispersing effect pigments within an aqueous effect pigment paste which comprises said pigments in an amount of at least 10 wt %, based on the total weight of the effect pigment paste.

Multicoat Paint System

A further subject of the present invention is a method for producing a multicoat paint system, by
(1a) applying an aqueous basecoat material to a substrate,
(2a) forming a polymer film from the coating material applied in stage (1a),
(1b) optionally applying a further aqueous basecoat material to the polymer film thus formed,
(2b) optionally forming a polymer film from the coating material applied in stage (1b),
(3) applying a clearcoat material to the resultant basecoat film(s), and subsequently
(4) jointly curing the basecoat film(s) together with the clearcoat film,

wherein the basecoat material of the invention is used in stage (1a) or—if the method further comprises stages (1b) and (2b)—in stage (1a) and/or (1b), preferably in stage (1b). All above-stated (preferred) versions of the effect pigment paste of the invention and of the aqueous basecoat material of the invention are also applicable to the method of the invention. The method is used for producing effect-imparting and color-and-effect-imparting multicoat paint systems.

The substrate used in stage (1a) preferably has an electrocoat film (EC), more preferably an electrocoat film applied by cathodic deposition of an electrocoat material, and the basecoat material used in stage (1a) is applied directly to the EC-coated, preferably metallic substrate, the electrocoat film (EC) applied to the substrate being preferably cured during implementation of stage (1a). Then, in stage (4), preferably, the basecoat film applied as per stages (1a) and (2a) to the preferably metallic substrate coated with a preferably cathodic cured electrocoat film is cured jointly with the further basecoat film, applied to the first basecoat film as per stages (1b) and (2b), and with the clearcoat film, applied in turn to the further basecoat film as per stage (3).

Application of the aqueous basecoat material of the invention takes place customarily to metallic or plastics substrates which have been pretreated with surfacer or primer-surfacer. Said basecoat material may optionally also be applied directly to the plastics substrate. Alternatively, the aqueous basecoat material of the invention may preferably be applied even without prior coating of the substrate, particularly a metallic substrate, with a surfacer or primer-surfacer: in this case, the method of the invention preferably includes stages (1b) and (2b), meaning that at least two basecoat films are applied, with the basecoat material of the invention being employed within stages (1a) and/or (1b), more preferably only within stage (1b). In this case the metallic substrate used is preferably coated with a cured electrocoat film.

If a metal substrate is to be coated, it is preferably coated with an electrocoat system as well, prior to the application of the surfacer or primer-surfacer or of the aqueous basecoat material of the invention. If a plastics substrate is being coated, it is preferably also pretreated prior to the application of the surfacer or primer-surfacer or of the aqueous basecoat material of the invention. The methods most frequently employed for such pretreatment are flaming, plasma treatment, and corona discharge. Flaming is used with preference. Application of the aqueous basecoat material or materials of the invention to a metallic substrate may take place in the film thicknesses that are customary in the context of the automobile industry, in the range from, for example, 5 to 100 micrometers, preferably 5 to 60 micrometers, especially preferably 5 to 30 micrometers. This is done employing spray application methods, such as, for example, compressed air spraying, airless spraying, high-speed rotation, electrostatic spray application (ESTA), alone or in conjunction with hot spray applications such as hot air spraying, for example.

Following application of the aqueous basecoat material or materials, it or they may be dried by known methods. For example, (one-component) basecoat materials, which are preferred, are flashed off at room temperature (23° C.) for 1 to 60 minutes and subsequently dried preferably at optionally slightly elevated temperatures of 30 to 90° C. Flashing off and drying in the context of the present invention means the evaporation of organic solvents and/or water, as a result of which the coating material becomes drier, but is not yet cured, or as yet no fully crosslinked coating film is formed.

Then a commercially customary clearcoat material is applied, again by usual methods, the film thicknesses again being within the usual ranges, of 5 to 100 micrometers, for example.

Following the application of the clearcoat material, it can be flashed off at room temperature (23° C.) for 1 to 60 minutes, for example, and optionally dried. The clearcoat is then cured together with the applied basecoat. At this stage, for example, crosslinking reactions take place, so producing a multicoat, effect-imparting and/or color-and-effect-imparting paint system on a substrate. Curing is preferably accomplished thermally at temperatures of 60 to 200° C.

The coating of plastics substrates takes place basically in a similar way to that of metallic substrates. Here, however, curing takes place generally at much lower temperatures of 30 to 90° C. Preference is therefore given to using two-component clearcoat materials.

The method of the invention can be used to coat metallic and nonmetallic substrates, more particularly plastics substrates, preferably automobile bodies or parts thereof. The method of the invention may also be used for dual finishing as part of OEM finishing. This means that a substrate which has been coated by means of the method of the invention is painted a second time, likewise by means of the method of the invention.

Said substrate from stage (1a) may also be a multicoat paint system possessing defects. In the case of this multicoat paint system substrate possessing defects, then, the substrate is an original finish which is to be made good or completely repainted. The method of the invention is suitable, accordingly, for the repair of defects on multicoat paint systems. Defects or film defects are terms used generally for defects on and in the coating, usually named according to their shape or their appearance. The skilled person is aware of a large number of possible kinds of such film defects. They are described for example in Rompp Lexikon, Lacke and Druckfarben, Georg Thieme Verlag, Stuttgart, N.Y., 1998, page 235, “Film defects”.

Determination Methods

1. Determination of the Nonvolatile Fraction

The nonvolatile fraction (the solids content) is determined according to DIN EN ISO 3251 (date: June 2008). 1 g of sample is weighed out into an aluminum dish which has been dried beforehand and the dish with sample is dried in a drying cabinet at 125° C. for 60 minutes, cooled in a desiccator, and then reweighed. The residue relative to the total amount of sample used corresponds to the nonvolatile fraction.

2. Determination of the Solubility of the Monomers of the Mixture (A) in Water that are Used in Preparing the Polymer (b)

The solubility of the monomers in water is determined via establishment of equilibrium with the gas space above the aqueous phase (in analogy to the reference X.-S. Chai, Q. X. Hou, F. J. Schork, Journal of Applied Polymer Science Vol. 99, 1296-1301 (2006)). For this purpose, in a 20 ml gas space sample tube, a defined volume of water, such as 2 ml, is admixed with the respective monomer in a mass so great that it is unable to dissolve, or at any rate to dissolve completely, in the volume of water selected. Additionally an emulsifier (10 ppm, based on total mass of the sample mixture) is added. To obtain the equilibrium concentration, the mixture is shaken continually. The supernatant gas phase is replaced by inert gas, thus re-establishing an equilibrium. In the gas phase removed, the fraction of the substance to be detected is measured in each case (by gas chromatography, for example). The equilibrium concentration in water can be determined by plotting the fraction of the monomer in the gas phase as a graph. The slope of the curve changes from a virtually constant value (S1) to a significantly negative slope (S2) as soon as the excess monomer fraction has been removed from the mixture. The equilibrium concentration here is reached at the point of intersection of the straight line with the slope S1 and of the straight line with the slope S2. The determination described is carried out at 25° C.

3. Determination of the Glass Transition Temperatures of Polymers Obtainable in Each Case from Monomers of the Mixtures (A), (B), and (C), Respectively

The glass transition temperature T_{g} is determined experimentally in a method based on DIN 51005 (date: August 2005) “Thermal Analysis (TA)—terms” and DIN 53765 “Thermal Analysis—Dynamic Scanning calorimetry (DSC)” (date: March 1994). This involves weighing out a 15 mg sample into a sample boat and introducing the boat into a DSC instrument. Cooling takes place to the starting temperature, after which 1st and 2nd measurement runs are carried out under inert gas purging (N₂) of 50 ml/min at a heating rate of 10 K/min, with cooling back to the starting temperature between the measurement runs. Measurement takes place in the temperature range from approximately 50° C. lower than the expected glass transition temperature to approximately 50° C. higher than the expected glass transition temperature. The glass transition temperature recorded, in accordance with DIN 53765, section 8.1, is the temperature in the 2nd measurement run at which half of the change in specific heat capacity (0.5 delta cp) has been reached. It is determined from the DSC diagram (plot of heat flow against temperature). It is the temperature corresponding to the point of intersection of the midline between the extrapolated baselines before and after the glass transition with the measurement plot. For a useful estimation of the glass transition temperature to be expected in the measurement, the known Fox equation can be employed. Since the Fox equation represents a good approximation, based on the glass transition temperatures of the homopolymers and their weight fractions, without including the molecular weight, it may be used as a useful tool for the skilled person at the synthesis stage, allowing a desired glass transition temperature to be set via a few goal-directed trials.

4. Determination of the Average Particle Size of the Polymer (b) and of the Optionally Employable Polyurethane-Polyurea Particles

The average particle size is determined by dynamic light scattering (photon correlation spectroscopy) (PCS) in a method based on DIN ISO 13321 (date: October 2004). Measurement takes place using a Malvern Nano S90 (from Malvern Instruments) at 25±1° C. The instrument covers a size range from 3 to 3000 nm and is equipped with a 4 mW He—Ne laser at 633 nm. Each of the samples are diluted with particle-free deionized water as dispersing medium and then measured in a 1 ml polystyrene cuvette at suitable scattering intensity. Evaluation was made using a digital correlator with assistance from the Zetasizer software, version 7.11 (from Malvern Instruments). Measurement is carried out five times and the measurements are repeated on a second, freshly prepared sample. For the polymer (b), the average particle size refers to the arithmetic numerical average of the measured mean particle diameter (Z-average mean; numerical average). The standard deviation of a 5-fold determination in this case is ≤4%. For the optionally employable polyurethane-polyurea particles, the average particle size refers to the arithmetic volume average of the average particle size of the individual preparations (V-average mean; volume average). The maximum deviation of the volume average from five individual measurements is ±15%. Verification takes place with polystyrene standards having certified particle sizes between 50 to 3000 nm.

5. Determination of Number-Average Molecular Weight

The number-average molecular weight (Mₙ) is determined, unless otherwise specified, using a model 10.00 vapor pressurosmometer (from Knauer) on concentration series in toluene at 50° C. with benzophenone as a calibrating substance for determining the experimental calibration constant of the instrument used, in accordance with E. Schröder, G. Müller, K.-F. Arndt, “Leitfaden der Polymercharakterisierung” [Principles of polymer characterization], Akademie-Verlag, Berlin, pp. 47-54, 1982.

6. Determination of the Film Thicknesses

The film thicknesses are determined according to DIN EN ISO 2808 (date: May 2007), method 12A, using the MiniTest® 3100-4100 instrument from ElektroPhysik.

7. Determination of the Lightness and of the Flop Index

For determination of the lightness or the flop index, the sample under analysis, such as a coating material composition, more particularly such as a waterborne basecoat material, is applied to a steel panel having dimensions of 32×60 cm and already coated with a surfacer system, in such a way, by means of dual electrostatic application, as to result in an overall film thickness (dry film thickness) of 12-17 μm. The first application step here is followed by a three-minute flash-off phase at room temperature (23° C.). Then another electrostatic application step is carried out, the resulting waterborne basecoat film is flashed off at room temperature for 10 minutes and is thereafter dried in a forced air oven at 80° C. for 10 minutes more. Applied to the dried waterborne basecoat film is a commercial two-component clearcoat material (ProGloss® from BASF Coatings GmbH) with a dry film thickness of 40-45 μm. The resulting clearcoat film is flashed off at room temperature for a time of 10 minutes. This is followed by curing in a forced air oven at 140° C. for a further 20 minutes. The substrate coated accordingly is subjected to measurement using a spectrophotometer from X-Rite (X-Rite MA68 Multi-Angle Spectrophotometer). During measurement, the surface is illuminated with a light source. Spectral detection in the visible range is carried out at a variety of angles. The spectral measurement values obtained in this way can be used, with incorporation of the standard spectral values and of the reflection spectrum of the light source used, to calculate color values in the CIEL*a*b* color space, where L* characterizes the lightness, a* the red-green value, and b* the yellow-blue value. This method is described for example in ASTM E2194-12 particularly for coatings which include at least one effect pigment as their pigment. The derived value which is often employed for quantifying the so-called metallic effect is the so-called flop index, which describes the relationship between lightness and observation angle (cf. A. B. J. Rodriguez, JOCCA, 1992 (4), pp. 150-153). The flop index (FL) can be calculated from the lightness values found for the viewing angles of 15°, 45° and 110° in accordance with the formula

FL=2.69(L*_{15°}−L_{110°})^{1.11}/(L*_{45°})^{0.86}

where L* stands for the lightness value measured at the respective angle (15°, 45° and 110°).

8. Determination of the Adhesion Properties

For determining the adhesion properties of the sample under investigation, such as a coating material composition, more particularly such as a waterborne basecoat material, multicoat paint systems are produced according to the following general procedure:

Original Finish

Atop a metallic substrate coated with a cured electrocoat system (CathoGuard® 800 from BASF Coatings GmbH), with dimensions of 10 cm×20 cm, the sample under investigation such as a waterborne basecoat material is applied by means of two-fold pneumatic application so as to produce an overall film thickness (dry film thickness) of 22-26 μm. Between the first and second pneumatic applications there is a three-minute flash-off time at room temperature (23° C.). After a further flash-off time at room temperature of 5 minutes, the resulting waterborne basecoat film is then dried in a forced air oven at 70° C. for 10 minutes. Applied to the dried waterborne basecoat film is a commercial two-component clearcoat material (ProGloss® from BASF Coatings GmbH) with a target film thickness of 40-45 μm. The resulting clearcoat film is flashed at room temperature for 10 minutes. This is followed by curing in a forced air oven at 140° C. for a further 20 minutes. The system obtainable in this way is referred to below as original finish (system a). Alternatively, the curing of the basecoat and clearcoat films is carried out at 20 minutes/125° C. (referred to hereinafter as underbaked original finish; system b) or at 30 minutes/160° C. (referred to hereinafter as overbaked original finish; system c).

Refinishes

Over the original finish, or alternatively over the underbaked original finish, a second basecoat/clearcoat system is applied in the same way as described for the original finishes, the curing of the second basecoat film and clearcoat film being carried out as for the original finish. This results in two different multicoat systems, referred to below as refinishes and distinguished by different drying conditions. System A is a refinish on system a, for which the second basecoat film and clearcoat film is cured at 140° C. for 20 minutes; system B denotes a refinish on system b, for which the corresponding curing of the second basecoat film and clearcoat film is carried out at 20 minutes/125° C.

The investigations of the adhesion properties were undertaken on unexposed samples and, additionally, after exposure to condensation water. For this purpose, the coated substrates are stored for a period of 10 days in a climate chamber under CH test conditions according to DIN EN ISO 6270-2 (date: September 2005). The coated substrates are subsequently subjected to the corresponding tests 24 hours after removal from the climate chamber.

For assessment of the technological properties, the multicoat paint systems are investigated for stone-chip adhesion. For this purpose the stone-chip test according to DIN EN ISO 20567-1 (April 2007), method B, was carried out. The resulting damage pattern was likewise assessed according to DIN EN ISO 20567-1.

In addition, steam jet tests are carried out according to DIN 55662 (December 2009), method B (application of a diagonal cross with a Sikkens scratch needle according to DIN EN ISO 17872 (June 2007), Annex A, to substrates having previously undergone a stone-chip test according to DIN EN ISO 20567-1, method B. For visual evaluation of the damage pattern, the following scale was used:

KW0=no change in sample

KW1=slight wash-off of the damage present

KW2=distinctly visible wash-off of the damage present in a coating film

KW3=complete delamination of a coating film in the region of the jet

KW4=complete delamination of a coating film beyond the jet region

KW5=detachment of the complete coating film down to the substrate

9. Determination of the Appearance Before and after Condensation Exposure and Also of Swelling and Blistering after Condensation Exposure

The leveling or the waviness of the coated substrates is assessed using a Wave scan instrument from Byk/Gardner. The substrates coated with a multicoat paint system are produced as described in section 4. (Determination of the adhesion properties).

For the purpose of assessing the appearance, a laser beam is directed at an angle of 60° onto the surface under analysis, and fluctuations in the reflected light in the shortwave range (0.3 to 1.2 mm) and in the longwave range (1.2 to 12 mm) are recorded by the instrument over a distance of 10 cm (long wave=LW; short wave=SW; the lower the values, the better the appearance). Furthermore, as a measure of the sharpness of an image reflected in the surface of the multicoat system, the instrument determines the characteristic variable “distinctness of image” (DOI) (the higher the value, the better the appearance). The corresponding investigations were performed on the unexposed samples and also after exposure to condensation water. For this purpose the coated substrates are stored over a period of 10 days in a climate chamber under CH test conditions according to DIN EN ISO 6270-2 (date: September 2005). The coated substrates, 24 hours after removal from the climate chamber, are then assessed for leveling or waviness; the samples are also inspected for swelling and blistering.

The incidence of blisters is assessed as follows through a combination of two values:
The number of the blisters is evaluated by a quantity figure from 1 to 5, with m1 denoting very few and m5 very many blisters.
The size of the blisters is evaluated by a size figure again from 1 to 5, with g1 denoting very small and g5 very large blisters.

The designation m0g0. accordingly, denotes a blister-free coating after condensation storage and represents a sat. result (sat.=satisfactory) in terms of blistering.

10. Assessment of the Incidence of Pops and Runs

To determine the propensity toward popping of a sample, multicoat paint systems are produced in a method based on DIN EN ISO 28199-1 (date: January 2010) and DIN EN ISO 28199-3 (date: January 2010) in accordance with the following general procedure:

A perforated steel plate with dimensions of 57 cm×20 cm (according to DIN EN ISO 28199-1, section 8.1, version A), coated with a standard electrocoat material (CathoGuard® 800 from BASF Coatings GmbH), is prepared in analogy to DIN EN ISO 28199-1, section 8.2 (version A). This is followed, in a method based on DIN EN ISO 28199-2, section 8.3, by electrostatic application of the sample under analysis, such as a coating material composition, in a single application in the form of a wedge with a target film thickness (film thickness of the dried material) in the range from 0 μm to 40 μm. The resulting film, without a prior flash-off time, is dried in a forced air oven at 80° C. for 5 minutes. The determination of the popping limit, i.e. of the film thickness from which pops occur, is made according to DIN EN ISO 28199-3, section 5.

11. Determination of the Storage Stability

For determination of the storage stability, 100 ml of the sample under analysis, such as a paste containing effect pigment, are introduced into a measuring beaker. After two weeks of storage at room temperature (23° C.), the sample in question is inspected for possible settling of the pigments and potential formation of a supernatant serum. In the case of the presence of a serum, the volume of the serum is read off and reported as a percentage fraction based on the total volume of the sample. After the storage described above, the sample is filtered using a standard plastic sieve with a mesh size of 270 μm, and the filter cake is examined for sedimentation.

12. Determination of the OH Number and the Acid Number

The OH number and the acid number are each determined by calculation.

### Inventive and Comparative Examples

The inventive and comparative examples below serve to illustrate the invention, but should not be interpreted as limiting.

Unless otherwise stated, the figures in parts are parts by weight, and figures in percent are percentages by weight in each case.

1. Preparation of an Aqueous Dispersion AD1

1.1 the Meanings of the Components Identified Below and Used in Preparing the Aqueous Dispersion AD1 are as Follows:

| | |
|---|---|
| DMEA | dimethylethanolamine |
| DI water | deionized water |
| EF 800 | Aerosol ® EF-800, commercially available |
| | emulsifier from Cytec |
| APS | ammonium peroxodisulfate |
| 1,6-HDDA | 1,6-hexanediol diacrylate |
| 2-HEA | 2-hydroxyethyl acrylate |
| MMA | methyl methacrylate |

1.2 Preparation of the Aqueous Dispersion AD1 Comprising a Multistage SCS Polyacrylate

Monomer Mixture (A), stage i.

80 wt % of items 1 and 2 as per table 1.1 below are placed in a steel reactor (5 L volume) with reflux condenser and are heated to 80° C. The remaining fractions of the components listed under “Initial charge” in table 1.1 are premixed in a separate vessel. This mixture and, separately therefrom, the “Initiator solution” (table 1.1, items 5 and 6), are added dropwise to the reactor simultaneously over the course of 20 minutes, a fraction of the monomers in the reaction solution, based on the total amount of monomers used in stage i., not exceeding 6.0 wt % throughout the reaction time. 30 minutes of stirring follow.

Monomer Mixture (B), Stage ii.

The components indicated under “Mono 1” in table 1.1 are premixed in a separate vessel. This mixture is added dropwise to the reactor over the course of 2 hours, the fraction of the monomers in the reaction solution, based on the total amount of monomers used in stage ii., not exceeding 6.0 wt % throughout the reaction time. 1 hour of stirring follows.

Monomer Mixture (C), Stage iii.

The components indicated under “Mono 2” in table 1.1 are premixed in a separate vessel. This mixture is added dropwise to the reactor over the course of 1 hour, a fraction of the monomers in the reaction solution, based on the total amount of monomers used in stage iii., not exceeding 6.0 wt % throughout the reaction time. 2 hours of stirring follows.

Thereafter the reaction mixture is cooled to 60° C. and the neutralizing mixture (table 1.1, items 20, 21, and 22) is premixed in a separate vessel. The neutralizing mixture is added dropwise to the reactor over the course of 40 minutes, the pH of the reaction solution being adjusted to a pH of 7.5 to 8.5. The reaction product is subsequently stirred for 30 minutes more, cooled to 25° C., and filtered.

The solids content of the resulting aqueous dispersion AD1 was determined for reaction monitoring. The result, together with the pH and the particle size determined, is reported in table 1.2.

TABLE 1.1
Aqueous dispersion AD1 comprising a
multistage polyacrylate

| | | AD1 |
|---|---|---|
| | Initial charge | |
| 1 | DI water | 41.81 |
| 2 | EF 800 | 0.18 |
| 3 | Styrene | 0.68 |
| 4 | n-Butyl acrylate | 0.48 |
| | Initiator solution | |
| 5 | DI water | 0.53 |
| 6 | APS | 0.02 |
| | Mono 1 | |
| 7 | DI water | 12.78 |
| 8 | EF 800 | 0.15 |
| 9 | APS | 0.02 |
| 10 | Styrene | 5.61 |
| 11 | n-Butyl acrylate | 13.6 |
| 12 | 1,6-HDDA | 0.34 |
| | Mono 2 | |
| 13 | DI water | 5.73 |
| 14 | EF 800 | 0.07 |
| 15 | APS | 0.02 |
| 16 | Methacrylic acid | 0.71 |
| 17 | 2-HEA | 0.95 |
| 18 | n-Butyl acrylate | 3.74 |
| 19 | MMA | 0.58 |
| | Neutralizing | |
| 20 | DI water | 6.48 |
| 21 | Butyl glycol | 4.76 |
| 22 | DMEA | 0.76 |

TABLE 1.2
Characteristics of the aqueous dispersion
AD1 or of the polymer comprised

| | AD1 |
|---|---|
| Solids content [wt %] | 25.6 |
| pH | 8.85 |
| Particle size [nm] | 246 |

2. Preparation of an Aqueous Polyurethane-Polyurea dispersion PD1

Preparation of a Partially Neutralized Prepolymer Solution

In a reaction vessel equipped with stirrer, internal thermometer, reflex condenser and electrical heating, 559.7 parts by weight of a linear polyester polyol and 27.2 parts by weight of dimethylol propionic acid (from GEO Speciality Chemicals) were dissolved under nitrogen in 344.5 parts by weight of methyl ethyl ketone. The linear polyester diol was prepared beforehand from dimerized fatty acid (Pripol® 1012, Croda), isophthalic acid (from BP Chemicals) and hexane-1,6-diol (from BASF SE) (weight ratio of the starting materials: dimeric fatty acid to isophthalic acid to hexane-1,6-diol=54.00:30.02:15.98) and had a hydroxyl number of 73 mg KOH/g solids fraction, an acid number of 3.5 mg KOH/g solids fraction, a calculated number-average molecular weight of 1379 g/mol, and a number-average molecular weight as determined by vapor pressure osmometry of 1350 g/mol. Added to the resulting solution at 30° C. in succession were 213.2 parts by weight of dicyclohexylmethane 4,4′-diisocyanate (Desmodur® W, Covestro AG), with an isocyanate content of 32.0 wt %, and 3.8 parts by weight of dibutyltin dilaurate (from Merck). This was followed by heating to 80° C. with stirring. Stirring continued at this temperature until the isocyanate content of the solution was constant at 1.49 wt %. Thereafter 626.2 parts by weight of methyl ethyl ketone were added to the prepolymer and the reaction mixture was cooled to 40° C. When 40° C. was reached, 11.8 parts by weight of triethylamine (from BASF SE) were added dropwise over the course of two minutes, and the batch was stirred for a further five minutes.

Reaction of Prepolymer with Diethylenetriamine Diketimine

30.2 parts by weight of a 71.9 wt % dilution of diethylenetriamine diketimine in methyl isobutyl ketone (ratio of prepolymer isocyanate groups with diethylenetriamine diketimine (having one secondary amino group): 5:1 mol/mol, corresponding to two NCO groups per blocked primary amino group) were subsequently admixed over the course of a minute, with the reaction temperature rising briefly by 1° C. following addition to the prepolymer solution. The diluted preparation of diethylenetriamine diketimine in methyl isobutyl ketone was prepared beforehand by azeotropic removal of water of reaction during the reaction of diethylenetriamine (from BASF SE) with methyl isobutyl ketone in methyl isobutyl ketone at 110-140° C. Dilution with methyl isobutyl ketone was used to set an amine equivalent mass (solution) of 124.0 g/eq. IR spectroscopy, on the basis of the residual absorption at 3310 cm⁻¹, found 98.5% blocking of the primary amino groups. The solids content of the polymer solution containing isocyanate groups was found to be 45.3%.

Dispersing and Vacuum Distillation

After 30 minutes of stirring at 40° C., the contents of the reactor were dispersed over 7 minutes into 1206 parts by weight of deionized water (23° C.). Methyl ethyl ketone was distilled off under reduced pressure from the resulting dispersion at 45° C., and any losses of solvent and of water were made up with deionized water, to give a solids content of 40 wt %. The resulting dispersion was white, stable, high in solids content and low in viscosity, contained crosslinked particles, and showed no sedimentation at all even after three months.

The characteristics of the resulting microgel dispersion (PD1) were as follows:
Solids content (130° C., 60 min, 1 g): 40.2 wt %
Methyl ethyl ketone content (GC): 0.2 wt %
Methyl isobutyl ketone content (GC): 0.1 wt %
Viscosity (23° C., rotational viscometer,
shear rate=1000/s): 15 mPa·s
Acid number: 17.1 mg KOH/g solids content
Degree of neutralization (calculated): 49%
pH (23° C.): 7.4
Particle size (photon correlation spectroscopy, volume average): 167 nm
Gel fraction (freeze-dried): 85.1 wt %
Gel fraction (130° C.): 87.3 wt %

3. Preparation of Precursors for Producing Effect Pigment Pastes

These precursors represent mixing varnishes for pasting of effect pigments.

3.1 Preparation of a Noninventive Mixing Varnish ML1

47.0 parts by weight of the primary dispersion of a graft copolymer as per German patent application DE 199 48 004 A1, example 2, page 20, lines 10-21, 29.2 parts by weight of deionized water, 6 parts by weight of 2,4,7,9-tetramethyl-5-decynediol, 52% in butyl glycol (available from BASF SE), 2.5 parts by weight of Dispex Ultra FA 4437 (available from BASF SE), 15 parts by weight of 1-propoxy-2-propanol and 0.3 part by weight of 10% dimethylethanolamine in water are mixed with one another. The resulting mixture is subsequently homogenized. ML1 was prepared on the basis of patent specification EP 1 799 783 B1 (in which it is “Mixing varnish 1” in paragraph [0072]). ML1 is used for preparing the premixes AS2, AS7, AS12 and AS17.

3.2 Preparation of a Noninventive Mixing Varnish ML2

81.9 parts by weight of deionized water, 2.7 parts by weight of Rheovis® AS 1130 (available from BASF SE), 8.9 parts by weight of 2,4,7,9-tetrametyl-5-decynediol, 52% in butyl glycol (available from BASF SE), 3.2 parts by weight of Dispex Ultra FA 4437 (available from BASF SE), and 3.3 parts by weight of 10% dimethylethanolamine in water are mixed with one another. The resulting mixture is subsequently homogenized. ML2 was prepared on the basis of patent specification EP 1 534 792 B1, column 11, lines 1-13 (paragraph [0056]). ML2 is used for preparing the premixes AS3, AS8, AS13 and AS18.

3.3 Preparation of an Inventive Mixing Varnish ML3

47.0 parts by weight of the aqueous dispersion AD1, 29.2 parts by weight of deionized water, 6 parts by weight of 2,4,7,9-tetramethyl-5-decynediol, 52% in butyl glycol (available from BASF SE), 2.5 parts by weight of Dispex Ultra FA 4437 (available from BASF SE), 15 parts by weight of 1-propoxy-2-propanol and 0.3 part by weight of 10% dimethylethanolamine in water are mixed with one another and the resulting mixture is subsequently homogenized.

3.4 Preparation of an Inventive Mixing Varnish ML4

47.0 parts by weight of the aqueous dispersion AD1, 29.2 parts by weight of deionized water, 6 parts by weight of 2,4,7,9-tetramethyl-5-decynediol, 52% in butyl glycol (available from BASF SE), 2.5 parts by weight of Dispex Ultra FA 4437 (available from BASF SE), 15 parts by weight of butyl glycol and 0.3 part by weight of 10% dimethylethanolamine in water are mixed with one another and the resulting mixture is subsequently homogenized.

3.5 Preparation of an Inventive Mixing Varnish ML5

47.0 parts by weight of the aqueous dispersion AD1, 41.2 parts by weight of deionized water, 6 parts by weight of 2,4,7,9-tetramethyl-5-decynediol, 52% in butyl glycol (available from BASF SE), 2.5 parts by weight of Dispex Ultra FA 4437 (available from BASF SE), 1.5 parts by weight of Rheovis® AS 1130 (available from BASF SE) and 1.8 parts by weight of 10% dimethylethanolamine in water are mixed with one another and the resulting mixture is subsequently homogenized.

3.6 Preparation of an Inventive Mixing Varnish ML6

47.38 parts by weight of the aqueous dispersion AD1, 42.29 parts by weight of deionized water, 6.05 parts by weight of 2,4,7,9-tetramethyl-5-decynediol, 52% in butyl glycol (available from BASF SE), 2.52 parts by weight of Dispex Ultra FA 4437 (available from BASF SE), 0.76 part by weight of Rheovis® AS 1130 (available from BASF SE) and 1.0 part by weight of 10% dimethylethanolamine in water are mixed with one another and the resulting mixture is subsequently homogenized.

3.7 Preparation of an Inventive Mixing Varnish ML7

47.0 parts by weight of the aqueous dispersion AD1, 41.2 parts by weight of deionized water, 6.0 parts by weight of 2,4,7,9-tetramethyl-5-decynediol, 52% in butyl glycol (available from BASF SE), 2.5 parts by weight of Dispex Ultra FA 4437 (available from BASF SE) and 1.5 parts by weight of Rheovis® AS 1130 (available from BASF SE) are mixed with one another and the resulting mixture is subsequently homogenized.

3.8 Preparation of an Inventive Mixing Varnish ML8

47.86 parts by weight of the aqueous dispersion AD1, 43.45 parts by weight of deionized water, 6.11 parts by weight of 2,4,7,9-tetramethyl-5-decynediol, 52% in butyl glycol (available from BASF SE) and 2.54 parts by weight of Dispex Ultra FA 4437 (available from BASF SE) are mixed with one another and the resulting mixture is subsequently homogenized.

3.9 Preparation of an Inventive Mixing Varnish ML9

16.30 parts by weight of a polyester prepared as per page 28, lines 13 to 33 (example BE1) of WO 2014/033135 A2, 73.37 parts by weight of deionized water, 6.05 parts by weight of 2,4,7,9-tetramethyl-5-decynediol, 52% in butyl glycol (available from BASF SE), 2.52 parts by weight of Dispex Ultra FA 4437 (available from BASF SE), 0.76 part by weight of Rheovis® AS 1130 (available from BASF SE) and 1.0 part by weight of 10% dimethylethanolamine in water are mixed with one another and the resulting mixture is subsequently homogenized.

3.10 Preparation of an Inventive Mixing Varnish ML10

89.67 parts by weight of deionized water, 6.05 parts by weight of 2,4,7,9-tetramethyl-5-decynediol, 52% in butyl glycol (available from BASF SE), 2.52 parts by weight of Dispex Ultra FA 4437 (available from BASF SE), 0.76 part by weight of Rheovis® AS 1130 (available from BASF SE) and 1.0 part by weight of 10% dimethylethanolamine in water are mixed with one another and the resulting mixture is subsequently homogenized.

4. Production of Color Pigment Pastes and Surfacer Pastes

4.1 Production of a White Paste wP1

The white paste is produced from 33.4 parts by weight of Tayca MT500 HD Titanium Rutile (available from Tayca Corporation), 52.6 parts by weight of an aqueous binder dispersion prepared as per WO 91/15528 A1, page 23, line 26 to page 24, line 24, 2.5 parts by weight of Disperbyk®-184 (available from BYK-Chemie GmbH), 2.7 parts by weight of 1-propoxy-2-propanol and 8.8 parts by weight of deionized water.

4.2 Production of a Red Paste rP1

The red paste is produced from 12 parts by weight of Sicotrans Red L 2818 (available from BASF SE), 49.7 parts by weight of an aqueous binder dispersion prepared as per WO 91/15528 A1, page 23, line 26 to page 24, line 24, 2 parts by weight of butyl glycol, 1 part by weight of 10% dimethylethanolamine in water, 2 parts by weight of Disperbyk®-184 (available from BYK-Chemie GmbH), 3 parts by weight of a commercial polyether (Pluriol® P900, available from BASF SE) and 30.3 parts by weight of deionized water.

4.3 Production of a Violet Paste vP1

The violet paste is produced from 18.4 parts by weight of the pigment Quindo® Violet 19 228-6902 (avaiable from Sun Chemical), 61.4 parts by weight of a polyurethane dispersion prepared as per WO 92/15405 A1, page 15, lines 23-28 in conjunction with page 14, line to page 15, line 13, 5.6 parts by weight of deionized water, 2.6 parts by weight of 10% dimethylethanolamine in water and 2 parts by weight of a commercial polyether (Pluriol® P900, available from BASF SE).

4.4 Production of a Black Paste sP1

The black paste is produced from 58.9 parts by weight of a polyurethane dispersion prepared as per WO 92/15405, page 14, line 13 to page 15, line 13, 10.1 parts by weight of carbon black (Color Black FW2 from Orion Engineered Carbons), 5 parts by weight of a polyester prepared as per example D, column 16, lines 37-59 of DE 40 09 858 A1, 7.8 parts by weight of 10% aqueous dimethylethanolamine solution, 2.2 parts by weight of a commercial polyether (Pluriol® P900, available from BASF SE), 7.6 parts by weight of butyl diglycol and 8.4 parts by weight of deionized water.

5. Production of Effect Pigment Pastes

5.1 Production of Effect Pigment Pastes AS1 to AS30

The components listed in tables 5.1 to 5.6 are combined in the order stated and stirred for at least 20 minutes until the mixture is homogeneous. Stirring is preferably carried out to establish a toroidal flow pattern—in other words, a donut effect is observed. The effect pigment pastes are also referred to below as effect pigment premixes.

TABLE 5.1
Production of effect pigment premixes AS1 to
AS3 (noninventive) and AS4 and AS5 (inventive)

| | AS1 | AS2 | AS3 | AS4 | AS5 |
|---|---|---|---|---|---|
| Effect pigment premix: | | | | | |
| Butyl glycol | 42.30 | 15 | — | — | — |
| 1-Propoxy-2-propanol | — | 15 | — | — | — |
| Mixing varnish ML2 | — | — | 75 | — | — |
| Mixing varnish ML5 | — | — | — | 70 | — |
| Mixing varnish ML7 | — | — | — | — | 70 |
| Commercial aluminum pigment | | | | | |
| Stapa ® Hydrolux 600, available from | 42.30 | 20 | 25 | 30 | 30 |
| Altana-Eckart | | | | | |
| Mixing varnish ML1 | — | 50 | — | — | — |
| Polyester prepared as per example D, | 14.10 | — | — | — | — |
| column 16, lines 37-59 of | | | | | |
| DE 40 09 858 A1 | | | | | |
| 10% dimethylethanolamine in water | 1.30 | — | — | — | — |
| Total: | 100.00 | 100.00 | 100.00 | 100.00 | 100.00 |

TABLE 5.2
Production of effect pigment premixes AS6 to
AS8 (noninventive) and AS9 and AS10 (inventive)

| | AS6 | AS7 | AS8 | AS9 | AS10 |
|---|---|---|---|---|---|
| Effect pigment premix: | | | | | |
| Butyl glycol | 42.30 | 15 | — | — | — |
| 1-Propoxy-2-propanol | — | 15 | — | — | — |
| Mixing varnish ML2 | — | — | 75 | — | — |
| Mixing varnish ML5 | — | — | — | 70 | — |
| Mixing varnish ML7 | — | — | — | — | 70 |
| Commercial aluminum pigment | | | | | |
| Stapa ® Hydrolan 701, available from | 42.30 | 20 | 25 | 30 | 30 |
| Altana-Eckart | | | | | |
| Mixing varnish ML1 | — | 50 | — | — | — |
| Polyester prepared as per example D, | 14.10 | — | — | — | — |
| column 16, lines 37-59 of | | | | | |
| DE 40 09 858 A1 | | | | | |
| 10% dimethylethanolamine in water | 1.30 | — | — | — | — |
| Total: | 100.00 | 100.00 | 100.00 | 100.00 | 100.00 |

TABLE 5.3
Production of effect pigment premixes AS11
to AS13 (noninventive) and AS14 and AS15 (inventive)

| | AS11 | AS12 | AS13 | AS14 | AS15 |
|---|---|---|---|---|---|
| Effect pigment premix: | | | | | |
| Butyl glycol | 42.30 | 15 | — | — | — |
| 1-Propoxy-2-propanol | — | 15 | — | — | — |
| Mixing varnish ML2 | — | — | 75 | — | — |
| Mixing varnish ML5 | — | — | — | 70 | — |
| Mixing varnish ML7 | — | — | — | — | 70 |
| Commercial aluminum pigment | | | | | |
| Stapa ® Hydrolux 2153, available from | 42.30 | 20 | 25 | 30 | 30 |
| Altana-Eckart | | | | | |
| Mixing varnish ML1 | — | 50 | — | — | — |
| Polyester prepared as per example D, | 14.10 | — | — | — | — |
| column 16, lines 37-59 of | | | | | |
| DE 40 09 858 A1 | | | | | |
| 10% dimethylethanolamine in water | 1.30 | — | — | — | — |
| Total: | 100.00 | 100.00 | 100.00 | 100.00 | 100.00 |

TABLE 5.4
Production of effect pigment premixes AS16
to AS18 (noninventive) and AS19 and AS20 (inventive)

| | AS16 | AS17 | AS18 | AS19 | AS20 |
|---|---|---|---|---|---|
| Effect pigment premix: | | | | | |
| Butyl glycol | 42.30 | 15 | — | — | — |
| 1-Propoxy-2-propanol | — | 15 | — | — | — |
| Mixing varnish ML2 | — | — | 75 | — | — |
| Mixing varnish ML5 | — | — | — | 70 | — |
| Mixing varnish ML7 | — | — | — | — | 70 |
| Commercial aluminum pigment | | | | | |
| Stapa ® Hydrolan 2153, available from | 42.30 | 20 | 25 | 30 | 30 |
| Altana-Eckart | | | | | |
| Mixing varnish ML1 | — | 50 | — | — | — |
| Polyester prepared as per example D, | 14.10 | — | — | — | — |
| column 16, lines 37-59 of | | | | | |
| DE 40 09 858 A1 | | | | | |
| 10% dimethylethanolamine in water | 1.30 | — | — | — | — |
| Total: | 100.00 | 100.00 | 100.00 | 100.00 | 100.00 |

TABLE 5.5
Production of effect pigment premixes AS21 to AS28 (inventive)

| Effect pigment premix: | AS21 | AS22 | AS23 | AS24 | AS25 | AS26 | AS27 | AS28 |
|---|---|---|---|---|---|---|---|---|
| Mixing varnish ML6 | 70.0 | — | 60.0 | — | 70.0 | — | 60.0 | — |
| Mixing varnish ML8 | — | 70.0 | — | 60.0 | — | 70.0 | — | 60.0 |
| Commercial | | | | | | | | |
| aluminum pigment | | | | | | | | |
| Stapa ® Hydrolux | 30.0 | 30.0 | 40.0 | 40.0 | — | — | — | — |
| 600, available | | | | | | | | |
| from Altana-Eckart | | | | | | | | |
| Commercial | | | | | | | | |
| aluminum pigment | | | | | | | | |
| Stapa ® Hydrolan | — | — | — | — | 30.0 | 30.0 | 40.0 | 40.0 |
| 2153, available | | | | | | | | |
| from Altana-Eckart | | | | | | | | |
| Total: | 100.0 | 100.0 | 100.0 | 100.0 | 100.0 | 100.0 | 100.0 | 100.0 |
| Pigment/polymer | 2.1 | 2.1 | 3.3 | 3.3 | 2.0 | 2.0 | 3.1 | 3.1 |
| (b) ratio: | | | | | | | | |

TABLE 5.6
Production of effect pigment premixes AS29
to AS30 (inventive)

| | AS29 | AS30 |
|---|---|---|
| Effect pigment premix: | | |
| Mixing varnish ML6 | 70.0 | 70.0 |
| Paliocrom ® Orange L 2804, iron oxide-coated | 30.0 | — |
| aluminum pigment, available from BASF SE | | |
| Paliocrom ® Gold L 2024, iron oxide-coated | — | 30.0 |
| aluminum pigment, available from BASF SE | | |
| Total: | 100.0 | 100.0 |

6. Production of Aqueous Basecoat Materials

6.1 Production of Noninventive Waterborne Basecoat Materials WBL1, WBL2, WBL4 and WBL5 and of Inventive Waterborne Basecoat Materials WBL3 and WBL6

The components listed under “aqueous phase” in table 6.1 are stirred together in the order stated to form an aqueous mixture. In the next step, a premix is produced from the components listed under “effect pigment premix”. This premix is added to the aqueous mixture. Stirring takes place then for 10 minutes, and deionized water and dimethylethanolamine are used to set a pH of 8 and a spray viscosity of 85-90 mPa·s (WBL1-WBL3) or 110 mPa·s (WBL4-WBL6) under a shearing load of 1000 s⁻¹, measured using a rotational viscometer (Rheolab QC with C-LTD80/QC heating system from Anton Paar) at 23° C.

TABLE 6.1
Production of waterborne basecoat materials WBL1 to WBL6

| | WBL1 | WBL2 | WBL3 | WBL4 | WBL5 | WBL6 |
|---|---|---|---|---|---|---|
| Aqueous phase: | | | | | | |
| 3% Na Mg phyllosilicate solution | 24.35 | 24.35 | 24.35 | — | — | — |
| Deionized water | 19.15 | 12.00 | 22.00 | 19.55 | 19.55 | 19.55 |
| Aquatix 8421, available from Altana/BYK-Chemie GmbH | — | — | — | 3.80 | 3.80 | 3.80 |
| 10% dimethnylethanolamine in water | — | — | — | 1.00 | 1.00 | 1.00 |
| 1-Propoxy-2-propanol | 2.20 | 2.20 | — | 2.20 | 2.20 | — |
| n-Butoxypropanol | 1.65 | 1.65 | 1.65 | 1.65 | 1.65 | 1.65 |
| 2-Ethylhexanol | 2.50 | 2.50 | 2.50 | 2.50 | 2.50 | 2.50 |
| Aqueous binder dispersion AD1 | 26.00 | 26.00 | 19.65 | 26.00 | 26.00 | 19.65 |
| Polyester prepared as per example D, column 16, | 2.60 | 4.50 | 4.50 | 2.60 | 4.50 | 4.50 |
| lines 37-59 of DE 40 09 858 A1 | | | | | | |
| Deionized water | — | — | — | 18.15 | 13.00 | 23.00 |
| Rheovis ® AS 1130 available from BASF SE | 0.65 | 0.30 | 0.65 | 0.65 | 0.30 | 0.65 |
| Deionized water | 1.00 | 1.00 | 1.00 | 1.00 | 1.00 | 1.00 |
| Melamine-formaldehyde resin (Resimene ® HM-2608 from Ineos) | 3.80 | 3.80 | 3.80 | 3.80 | 3.80 | 3.80 |
| 10% dimethylethanolamine in water | 0.90 | 1.10 | 1.10 | 0.90 | 1.10 | 1.10 |
| Pluriol ® P900, available from BASF SE | 1.00 | 1.00 | 1.00 | 1.00 | 1.00 | 1.00 |
| Polyurethane-modified polacrylate prepared as per page 7, | 3.80 | 3.80 | 3.80 | 3.80 | 3.80 | 3.80 |
| line 55 to page 8, line 23 of DE4437535 A1 | | | | | | |
| Isobutanol | 2.40 | 2.40 | 2.40 | 2.40 | 2.40 | 2.40 |
| Butyl glycol | — | 5.60 | 1.30 | — | 5.60 | 1.30 |
| 50 wt % solution of Rheovis ® PU1250 in butyl glycol | 0.80 | 0.80 | 0.80 | 0.80 | 0.80 | 0.80 |
| (available from BASF SE) | | | | | | |
| Byketol ®-WS from Altana/BYK-Chemie GmbH | 1.00 | 1.00 | 1.00 | 1.00 | 1.00 | 1.00 |
| Effect pigment premix: | | | | | | |
| Mixture of two commercial aluminum pigments, | 4.50 | 4.50 | 4.50 | 4.50 | 4.50 | 4.50 |
| available from Altana-Eckart (Stapa ® Hydrolux 2154 & | | | | | | |
| VP5645 in ratio of 1.0:2.75) | | | | | | |
| Butyl glycol | 5.60 | — | 2.25 | 5.60 | — | 2.25 |
| 1-Propoxy-2-propanol | — | — | 2.25 | | — | 2.25 |
| Polyester prepared as per example D, column 16, | 1.90 | — | — | 1.90 | — | — |
| lines 37-59 of DE 40 09 858 A1 | | | | | | |
| 10% dimethylethanolamine in water | 0.20 | — | — | 0.20 | — | — |
| Mixing varnish ML2 (noninventive) | — | 13.50 | — | — | 13.50 | — |
| Mixing varnish ML3 (inventive) | — | — | 13.50 | — | — | 13.50 |
| Total: | 106.00 | 112.00 | 114.00 | 105.00 | 113.00 | 115.00 |

6.2 Production of Noninventive Waterborne Basecoat Materials WBL7 and WBL10 and of Inventive Waterborne Basecoat Materials WBL8, WBL9, WBL11 and WB12

The components listed under “aqueous phase” in table 6.2 are stirred together in the order stated to form an aqueous mixture. In the next step, a premix is produced from the components listed under “effect pigment premix”. This premix is added to the aqueous mixture. Stirring takes place then for 10 minutes, and deionized water and dimethylethanolamine are used to set a pH of 8 and a spray viscosity of 85±5 mPa·s (WBL7-WBL9) or 115±5 mPa·s (WBL10-WBL12) under a shearing load of 1000 s⁻¹, measured using a rotational viscometer (Rheolab QC with C-LTD80/QC heating system from Anton Paar) at 23° C.

TABLE 6.2
Production of waterborne basecoat materials WBL7 to WBL12

| | WBL7 | WBL8 | WBL9 | WBL10 | WBL11 | WBL12 |
|---|---|---|---|---|---|---|
| Aqueous phase: | | | | | | |
| 3% Na Mg phyllosilicate solution | 24.35 | 24.35 | 24.35 | — | — | — |
| Deionized water | 14.05 | 14.05 | 16.40 | 19.55 | 19.55 | 19.55 |
| Aquatix 8421, available from Altana/BYK-Chemie GmbH | — | — | — | 3.8 | 3.8 | 3.8 |
| 10% dimethylethanolamine in water | — | — | — | 1 | 1 | 1 |
| 1-Propoxy-2-propanol | 2.25 | — | — | 2.25 | — | — |
| n-Butoxypropanol | 1.65 | 1.65 | 1.65 | 1.65 | 1.65 | 1.65 |
| 2-Ethylhexanol | 2.50 | 2.50 | 2.50 | 2.50 | 2.50 | 2.50 |
| Aqueous binder dispersion AD1 | 18.60 | 19.65 | 19.65 | 18.60 | 19.65 | 19.65 |
| Polyester prepared as per example D, column 16, | 4.50 | 4.50 | 4.50 | 4.50 | 4.50 | 4.50 |
| lines 37-59 of DE 40 09 858 A1 | | | | | | |
| Deionized water | — | — | — | 14.05 | 14.05 | 16.40 |
| Rheovis ® AS 1130 available from BASF SE | 0.65 | 0.65 | 0.45 | 0.65 | 0.65 | 0.45 |
| Deionized water | 1.00 | 1.00 | 1.00 | 1.00 | 1.00 | 1.00 |
| Melamine-formaldehyde resin (Resimene ® HM-2608 from Ineos) | 3.80 | 3.80 | 3.80 | 3.80 | 3.80 | 3.80 |
| 10% dimethylethanolamine in water | 1.10 | 1.10 | 0.90 | 1.10 | 1.10 | 0.90 |
| Pluriol ® P900, available from BASF SE | 1.00 | 1.00 | 1.00 | 1.00 | 1.00 | 1.00 |
| Polyurethane-modified polyacrylate prepared as per page 7, | 3.80 | 3.80 | 3.80 | 3.80 | 3.80 | 3.80 |
| line 55 to page 8, line 23 of DE4437535 A1 | | | | | | |
| Isobutanol | 2.40 | 2.40 | 2.40 | 2.40 | 2.40 | 2.40 |
| Butyl glycol | 1.30 | 1.30 | 3.30 | 1.30 | 1.30 | 3.30 |
| 50 wt % solution of Rheovis ® PU1250 in butyl glycol | 0.80 | 0.80 | 0.80 | 0.80 | 0.80 | 0.80 |
| (available from BASF SE) | | | | | | |
| Byketol ®-WS from Altana/BYK-Chemie GmbH | 1.00 | 1.00 | 1.00 | 1.00 | 1.00 | 1.00 |
| Effect pigment premix: | | | | | | |
| Mixture of two commercial aluminum pigments, | 4.50 | 4.50 | 4.50 | 4.50 | 4.50 | 4.50 |
| available from Altana-Eckart (Stapa ® Hydrolux 2154 & | | | | | | |
| VP5645 in ratio of 1.0:2.75) | | | | | | |
| Butyl glycol | 2.25 | 4.50 | 4.50 | 2.25 | 4.50 | 4.50 |
| Mixing varnish ML1 (noninventive) | 13.50 | — | — | 13.50 | — | — |
| Mixing varnish ML4 (inventive) | — | 13.50 | — | — | 13.50 | — |
| Mixing varnish ML5 (inventive) | — | — | 13.50 | — | — | 13.50 |
| Total: | 105.00 | 106.05 | 110.00 | 105.00 | 106.05 | 110.00 |

6.3 Production of Noninventive Waterborne Basecoat Materials WBL13 to WBL15, WBL18 to WBL20, WBL23 to WBL25 and WBL28 to WBL30 and of Inventive Waterborne Basecoat Materials WBL16, WBL17, WBL21, WBL22, WBL26, WBL27, WBL31 and WBL32

The components listed under “aqueous phase” in tables 6.3 to 6.6 are stirred together in each case in the order stated to form an aqueous mixture. In the next step, a premix is produced in each case from the components listed under “effect pigment premix”. The corresponding premix is added to the respective aqueous mixture. Stirring takes place then for 10 minutes, and deionized water and dimethylethanolamine are used to set a pH of 8 and a spray viscosity of 75±5 mPa·s under a shearing load of 1000 s⁻¹, measured using a rotational viscometer (Rheolab QC with C-LTD80/QC heating system from Anton Paar) at 23° C.

TABLE 6.3
Production of waterborne basecoat materials WBL13 to WBL15
(noninventive) and WBL16 and WBL17 (inventive)

| | WBL13 | WBL14 | WBL15 | WBL16 | WBL17 |
|---|---|---|---|---|---|
| Aqueous phase: | | | | | |
| 3% Na Mg phyllosilicate solution | 25.00 | 25.00 | 25.00 | 25.00 | 25.00 |
| Deionized water | 8.70 | 8.70 | 8.70 | 8.70 | 8.70 |
| 1-Propoxy-2-propanol | 1.40 | 1.40 | 1.40 | 1.40 | 1.40 |
| n-Butoxypropanol | 1.40 | 1.40 | 1.40 | 1.40 | 1.40 |
| 2-Ethylhexanol | 1.85 | 1.85 | 1.85 | 1.85 | 1.85 |
| Aqueous binder dispersion AD1 | 21.80 | 21.80 | 13.30 | 18.90 | 15.00 |
| Aqueous polyurethane-polyurea dispersion PD1 | 6.40 | 6.40 | 6.40 | 6.40 | 6.40 |
| Polyester prepared as per page 28, lines 13 to 33 | 1.95 | 1.95 | 1.95 | 1.95 | 1.95 |
| (example BE1) of WO 2014/033135 A2 | | | | | |
| Polyester prepared as per example D, column 16, lines 37-59 | — | 2.10 | 2.10 | 2.10 | 2.10 |
| of DE 40 09 858 A1 | | | | | |
| Rheovis ® AS 1130 available from BASF SE | 0.40 | 0.40 | 0.40 | 0.40 | 0.40 |
| Deionized water | 3.00 | 3.00 | 3.00 | 3.00 | 3.00 |
| Melamine-formaldehyde resin (Resimene ® HM-2608 from Ineos) | 3.70 | 3.70 | 3.70 | 3.70 | 3.70 |
| 10% dimethylethanolamine in water | — | 0.20 | 0.20 | 0.20 | 0.20 |
| Pluriol ® P900, available from BASF SE | 0.90 | 0.90 | 0.90 | 0.90 | 0.90 |
| Isobutanol | 3.00 | 3.00 | 3.00 | 3.00 | 3.00 |
| Butyl glycol | — | 6.20 | — | 6.20 | 6.20 |
| 50 wt % solution of Rheovis ® PU1250 in butyl glycol | 0.40 | 0.40 | 0.40 | 0.40 | 0.40 |
| (available from BASF SE) | | | | | |
| Effect pigment premix: | | | | | |
| Commercial aluminum pigment, available from Altana-Eckart | 6.20 | 6.20 | 6.20 | 6.20 | 6.20 |
| (Stapa ® Hydrolux 600) | | | | | |
| Butyl glycol | 6.20 | — | 4.70 | 6.20 | — |
| Polyester prepared as per example D, column 16, lines 37-59 | 2.10 | — | — | — | — |
| of DE 40 09 858 A1 | | | | | |
| 10% dimethylethanolamine in water | 0.20 | — | — | — | — |
| 1-Propoxy-2-propanol | — | — | 4.70 | — | — |
| Mixing varnish ML2 (noninventive) | — | 18.60 | — | — | — |
| Mixing varnish ML1 (noninventive) | — | — | 15.50 | — | — |
| Mixing varnish ML7 (inventive) | — | — | — | 6.20 | 14.50 |
| Total: | 94.60 | 113.20 | 104.80 | 97.90 | 102.30 |

TABLE 6.4
Production of waterborne basecoat materials WBL18 to WBL20
(noninventive) and WBL21 and WBL22 (inventive)

| | WBL18 | WBL19 | WBL20 | WBL21 | WBL22 |
|---|---|---|---|---|---|
| Aqueous phase: | | | | | |
| 3% Na Mg phyllosilicate solution | 25.00 | 25.00 | 25.00 | 25.00 | 25.00 |
| Deionized water | 8.70 | 8.70 | 8.70 | 8.70 | 8.70 |
| 1-Propoxy-2-propanol | 1.40 | 1.40 | 1.40 | 1.40 | 1.40 |
| n-Butoxypropanol | 1.40 | 1.40 | 1.40 | 1.40 | 1.40 |
| 2-Ethylhexanol | 1.85 | 1.85 | 1.85 | 1.85 | 1.85 |
| Aqueous binder dispersion AD1 | 21.80 | 21.80 | 12.60 | 18.60 | 14.50 |
| Aqueous polyurethane-polyurea dispersion PD1 | 6.40 | 6.40 | 6.40 | 6.40 | 6.40 |
| Polyester prepared as per page 28, lines 13 to 33 | 1.95 | 1.95 | 1.95 | 1.95 | 1.95 |
| (example BE1) of WO 2014/033135 A2 | | | | | |
| Polyester prepared as per example D, column 16, lines 37-59 | — | 2.20 | 2.20 | 2.20 | 2.20 |
| of DE 40 09 858 A1 | | | | | |
| Rheovis ® AS 1130 available from BASF SE | 0.40 | 0.40 | 0.40 | 0.40 | 0.40 |
| Deionized water | 3.00 | 3.00 | 3.00 | 3.00 | 3.00 |
| Melamine-formaldehyde resin (Resimene ® HM-2608 from Ineos) | 3.70 | 3.70 | 3.70 | 3.70 | 3.70 |
| 10% dimethylethanolamine in water | — | 0.20 | 0.20 | 0.20 | 0.20 |
| Pluriol ® P900, available from BASF SE | 0.90 | 0.90 | 0.90 | 0.90 | 0.90 |
| Isobutanol | 3.00 | 3.00 | 3.00 | 3.00 | 3.00 |
| Butyl glycol | — | 6.70 | — | | 6.70 |
| 50 wt % solution of Rheovis ® PU1250 in butyl glycol | 0.40 | 0.40 | 0.40 | 0.40 | 0.40 |
| (available from BASF SE) | | | | | |
| Effect pigment premix: | | | | | |
| Commercial aluminum pigment, available from Altana-Eckart | 6.70 | 6.70 | 6.70 | 6.70 | 6.70 |
| (Stapa ® Hydrolan 701) | | | | | |
| Butyl glycol | 6.70 | — | 5.00 | 6.70 | — |
| Polyester prepared as per example D, column 16, lines 37-59 | 2.20 | — | — | — | — |
| of DE 40 09 858 A1 | | | | | |
| 10% dimethylethanolamine in water | 0.20 | — | — | — | — |
| 1-Propoxy-2-propanol | — | — | 5.00 | — | — |
| Mixing varnish ML2 (noninventive) | — | 20.10 | — | — | — |
| Mixing varnish ML1 (noninventive) | — | — | 16.80 | — | — |
| Mixing varnish ML7 (inventive) | — | — | — | 6.70 | 15.60 |
| Total: | 97.50 | 115.80 | 106.60 | 99.20 | 104.00 |

TABLE 6.5
Production of waterborne basecoat materials WBL23 to WBL25
(noninventive) and WBL26 and WBL27 (inventive)

| | WBL23 | WBL24 | WBL25 | WBL26 | WBL27 |
|---|---|---|---|---|---|
| Aqueous phase: | | | | | |
| 3% Na Mg phyllosilicate solution | 25.00 | 25.00 | 25.00 | 25.00 | 25.00 |
| Deionized water | 8.70 | 8.70 | 8.70 | 8.70 | 8.70 |
| 1-Propoxy-2-propanol | 1.40 | 1.40 | 1.40 | 1.40 | 1.40 |
| n-Butoxypropanol | 1.40 | 1.40 | 1.40 | 1.40 | 1.40 |
| 2-Ethylhexanol | 1.85 | 1.85 | 1.85 | 1.85 | 1.85 |
| Aqueous binder dispersion AD1 | 21.80 | 21.80 | 13.30 | 18.90 | 15.00 |
| Aqueous polyurethane-polyurea dispersion PD1 | 6.40 | 6.40 | 6.40 | 6.40 | 6.40 |
| Polyester prepared as per page 28, lines 13 to 33 | 1.95 | 1.95 | 1.95 | 1.95 | 1.95 |
| (example BE1) of WO 2014/033135 A2 | | | | | |
| Polyester prepared as per example D, column 16, lines 37-59 | — | 2.10 | 2.10 | 2.10 | 2.10 |
| of DE 40 09 858 A1 | | | | | |
| Rheovis ® AS 1130 available from BASF SE | 0.40 | 0.40 | 0.40 | 0.40 | 0.40 |
| Deionized water | 3.00 | 3.00 | 3.00 | 3.00 | 3.00 |
| Melamine-formaldehyde resin (Resimene ® HM-2608 from Ineos) | 3.70 | 3.70 | 3.70 | 3.70 | 3.70 |
| 10% dimethylethanolamine in water | — | 0.20 | 0.20 | 0.20 | 0.20 |
| Pluriol ® P900, available from BASF SE | 0.90 | 0.90 | 0.90 | 0.90 | 0.90 |
| Isobutanol | 3.00 | 3.00 | 3.00 | 3.00 | 3.00 |
| Butyl glycol | — | 6.20 | — | — | 6.20 |
| 50 wt % solution of Rheovis ® PU1250 in butyl glycol | 0.40 | 0.40 | 0.40 | 0.40 | 0.40 |
| (available from BASF SE) | | | | | |
| Effect pigment premix: | | | | | |
| Commercial aluminum pigment, available from Altana-Eckart | 6.20 | 6.20 | 6.20 | 6.20 | 6.20 |
| (Stapa ® Hydrolux 2153) | | | | | |
| Butyl glycol | 6.20 | — | 4.70 | 6.20 | — |
| Polyester prepared as per example D, column 16, lines 37-59 | 2.10 | — | — | — | — |
| of DE 40 09 858 A1 | | | | | |
| 10% dimethylethanolamine in water | 0.20 | — | — | — | — |
| 1-Propoxy-2-propanol | — | — | 4.70 | — | — |
| Mixing varnish ML2 (noninventive) | — | 18.60 | — | — | — |
| Mixing varnish ML1 (noninventive) | — | — | 15.50 | — | — |
| Mixing varnish ML7 (inventive) | — | — | — | 6.20 | 14.50 |
| Total: | 94.60 | 113.20 | 104.80 | 97.90 | 102.30 |

TABLE 6.6
Production of waterborne basecoat materials WBL28 to WBL30
(noninventive) and WBL31 and WBL32 (inventive)

| | WBL28 | WBL29 | WBL30 | WBL31 | WBL32 |
|---|---|---|---|---|---|
| Aqueous phase: | | | | | |
| 3% Na Mg phyllosilicate solution | 25.00 | 25.00 | 25.00 | 25.00 | 25.00 |
| Deionized water | 8.70 | 8.70 | 8.70 | 8.70 | 8.70 |
| 1-Propoxy-2-propanol | 1.40 | 1.40 | 1.40 | 1.40 | 1.40 |
| n-Butoxypropanol | 1.40 | 1.40 | 1.40 | 1.40 | 1.40 |
| 2-Ethylhexanol | 1.85 | 1.85 | 1.85 | 1.85 | 1.85 |
| Aqueous binder dispersion AD1 | 21.80 | 21.80 | 13.30 | 18.90 | 15.00 |
| Aqueous polyurethane-polyurea dispersion PD1 | 6.40 | 6.40 | 6.40 | 6.40 | 6.40 |
| Polyester prepared as per page 28, lines 13 to 33 | 1.95 | 1.95 | 1.95 | 1.95 | 1.95 |
| (example BE1) of WO 2014/033135 A2 | | | | | |
| Polyester prepared as per example D, column 16, lines 37-59 | — | 2.10 | 2.10 | 2.10 | 2.10 |
| of DE 40 09 858 A1 | | | | | |
| Rheovis ® AS 1130 available from BASF SE | 0.40 | 0.40 | 0.40 | 0.40 | 0.40 |
| Deionized water | 3.00 | 3.00 | 3.00 | 3.00 | 3.00 |
| Melamine-formaldehyde resin (Resimene ® HM-2608 from Ineos) | 3.70 | 3.70 | 3.70 | 3.70 | 3.70 |
| 10% dimethylethanolamine in water | — | 0.20 | 0.20 | 0.20 | 0.20 |
| Pluriol ® P900, available from BASF SE | 0.90 | 0.90 | 0.90 | 0.90 | 0.90 |
| Isobutanol | 3.00 | 3.00 | 3.00 | 3.00 | 3.00 |
| Butyl glycol | — | 6.20 | — | — | 6.20 |
| 50 wt % solution of Rheovis ® PU1250 in butyl glycol | 0.40 | 0.40 | 0.40 | 0.40 | 0.40 |
| (Rheovis ® PU1250 available from BASF SE) | | | | | |
| Effect pigment premix: | | | | | |
| Commercial aluminum pigment, available from Altana-Eckart | 6.20 | 6.20 | 6.20 | 6.20 | 6.20 |
| (Stapa ® Hydrolan 2153) | | | | | |
| Butyl glycol | 6.20 | — | 4.70 | 6.20 | — |
| Polyester prepared as per example D, column 16, lines 37-59 | 2.10 | — | — | — | — |
| of DE 40 09 858 A1 | | | | | |
| 10% dimethylethanolamine in water | 0.20 | — | — | — | — |
| 1-Propoxy-2-propanol | — | — | 4.70 | — | — |
| Mixing varnish ML2 (noninventive) | — | 18.60 | — | — | — |
| Mixing varnish ML1 (noninventive) | — | — | 15.50 | — | — |
| Mixing varnish ML7 (inventive) | — | — | — | 6.20 | 14.50 |
| Total: | 94.60 | 113.20 | 104.80 | 97.90 | 102.30 |

6.4 Production of Noninventive Waterborne Basecoat Material WBL33 and of Inventive Waterborne Basecoat Material WBL34

The components listed under “aqueous phase” in table 6.7 are stirred together in the order stated to form an aqueous mixture. In the next step, one premix each is produced from the components listed under “effect pigment premix I” and under “effect pigment premix II”, respectively. These premixes are then each added to the aqueous mixture. Stirring takes place then for 10 minutes, and deionized water and dimethylethanolamine are used to set a pH of 8 and a spray viscosity of 80±5 mPa·s under a shearing load of 1000 s⁻¹, measured using a rotational viscometer (Rheolab QC with C-LTD80/QC heating system from Anton Paar) at 23° C.

TABLE 6.7
Production of waterborne basecoat materials
WBL33 and WBL34

| | WBL33 | WBL34 |
|---|---|---|
| Aqueous phase: | | |
| 3% Na Mg phyllosilicate solution | 6.72 | 6.85 |
| Deionized water | 6.05 | 6.16 |
| 2-Ethylhexanol | 2.69 | 2.74 |
| Aqueous binder dispersion AD1 | 12.23 | 12.47 |
| Aqueous polyurethane-polyurea dispersion PD1 | 25.27 | 25.75 |
| Polyester prepared as per page 28, lines 13 to 33 | 4.17 | 4.25 |
| (example BE1) of WO 2014/033135 A2 | | |
| Melamine-formaldehyde resin (Cymel ® 203 from | 9.28 | 9.45 |
| Allnex) | | |
| 10% dimethylethanolamine in water | 0.13 | 0.00 |
| 2,4,7,9-Tetramethyl-5-decynediol, 52% in butyl glycol | 0.13 | 0.14 |
| (available from BASF SE) | | |
| Isobutanol | 2.69 | 2.74 |
| Butyl glycol | 4.70 | 4.79 |
| White paste wP1 | 0.12 | 0.13 |
| Red paste rP1 | 0.19 | 0.20 |
| Violet paste vP1 | 0.62 | 0.67 |
| Black paste sP1 | 3.50 | 3.77 |
| Effect pigment premix I: | | |
| Mixture of two commercial aluminum pigments, | 2.69 | 2.90 |
| available from Altana-Eckart (Stapa ® Hydrolux | | |
| 2154 Hydrolux 8154 in a ratio of 1.0:0.75) | | |
| Butyl glycol | 2.02 | 2.18 |
| Mixing varnish ML6 (inventive) | — | 11.90 |
| Mixing varnish ML2 (noninventive) | 14.11 | — |
| Effect pigment premix II: | | |
| Mixing varnish ML2 (noninventive) | 2.02 | 2.18 |
| Commercial mica pigment Mearlin Ext. Super | 0.67 | 0.73 |
| Gold 239 from BASF SE | | |
| Total: | 100.00 | 100.00 |

6.5 Production of Noninventive Waterborne Basecoat Materials WBL34a and WBL34b with the Same Overall Composition as in Inventive Waterborne Basecoat material WBL34

As a direct comparison to the inventive waterborne basecoat material WBL34 (production see section 6.4), two noninventive alternative waterborne basecoat materials were produced, having an overall composition the same as that of WBL34, but differing in the mode of production, i.e., in the use of effect pigment premix I. The formulations of WBL34a and WBL34b are contrasted with the formulation of WBL34 in table 6.8 below.

For WBL34a, in contrast to WBL34, mixing varnish ML9 was used instead of mixing varnish ML6, the former contrasting with ML6 through the replacement of the polymer (b) used in accordance with the invention and present in dispersion AD1 by the polyester component listed under “aqueous phase” in the formulation of WBL34. The fraction of this polyester component in the “aqueous phase” of WBL34a was reduced accordingly. The fraction of the polymer (b) used in accordance with the invention and present in dispersion AD1, which in the case of WBL34 was introduced into the formulation via the effect pigment premix I and/or the mixing varnish ML6 present therein, was raised correspondingly, in contrast, in the “aqueous phase” of WBL34a.

In an analogous way, for the production of WBL34b in contrast to WBL34, the mixing varnish ML6 was replaced by the mixing varnish ML10, for which, in comparison to ML6, dispersion AD1 was not used at all, the amount thereof instead being replaced by deionized water. The fraction of this polyester component in the “aqueous phase” of WBL34b was reduced accordingly. The fraction of the polymer (b) used in accordance with the invention and present in dispersion AD1, which in the case of WBL34 was introduced into the formulation via the effect pigment premix I containing ML6, was raised correspondingly, in contrast, in the “aqueous phase” of WBL34b.

The production of WBL34a and WBL34b took place in the same way as for WBL34: The components listed under “aqueous phase” in table 6.8 are stirred together in the order stated to form an aqueous mixture. In the next step, one premix each is produced from the components listed under “effect pigment premix I” and under “effect pigment premix II”, respectively. These premixes are then each added to the aqueous mixture. Stirring takes place then for 10 minutes, and deionized water and dimethylethanolamine are used to set a pH of 8 and a spray viscosity of 80±5 mPa·s under a shearing load of 1000 s⁻¹, measured using a rotational viscometer (Rheolab QC with C-LTD80/QC heating system from Anton Paar) at 23° C.

TABLE 6.8
Production of waterborne basecoat materials
WBL33a and WBL34b (both noninventive) and of waterborne
basecoat material WBL34 (inventive)

| | WBL34 | WBL34a | WBL34b |
|---|---|---|---|
| Aqueous phase: | | | |
| 3% Na Mg phyllosilicate solution | 6.85 | 6.85 | 6.85 |
| Deionized water | 6.16 | 2.47 | 0.53 |
| 2-Ethylhexanol | 2.74 | 2.74 | 2.74 |
| Aqueous binder dispersion AD1 | 12.47 | 18.10 | 18.10 |
| Aqueous polyurethane-polyurea | 25.75 | 25.75 | 25.75 |
| dispersion PD1 | | | |
| Polyester prepared as per page 28, | 4.25 | 2.31 | 4.25 |
| lines 13 to 33 (example BE1) of | | | |
| WO 2014/033135 A2 | | | |
| Melamine-formaldehyde resin | 9.45 | 9.45 | 9.45 |
| (Cymel ® 203 from Allnex) | | | |
| 2,4,7,9-Tetramethyl-5-decynediol, | 0.14 | 0.14 | 0.14 |
| 52% in BG | | | |
| Isobutanol | 2.74 | 2.74 | 2.74 |
| Butyl glycol | 4.79 | 4.79 | 4.79 |
| White paste wP1 | 0.13 | 0.13 | 0.13 |
| Red paste rP1 | 0.20 | 0.20 | 0.20 |
| Violet paste vP1 | 0.67 | 0.67 | 0.67 |
| Black paste sP1 | 3.77 | 3.77 | 3.77 |
| Effect pigment premix I: | | | |
| Mixture of two commercial aluminum | 2.90 | 2.90 | 2.90 |
| pigments, available from Altana-Eckart | | | |
| (Stapa ® Hydrolux 2154 Hydrolux | | | |
| 8154 in a ratio of 1.0:0.75) | | | |
| Butyl glycol | 2.18 | 2.18 | 2.18 |
| Mixing varnish ML6 | 11.90 | | — |
| Mixing varnish ML9 | — | 11.90 | — |
| Mixing varnish ML10 | — | — | 11.90 |
| Effect pigment premix II: | | | |
| Mixing varnish ML2 | 2.18 | 2.18 | 2.18 |
| Commercial mica pigment Mearlin | 0.73 | 0.73 | 0.73 |
| Ext. Super Gold 239 from BASF SE | | | |
| Total: | 100.00 | 100.00 | 100.00 |

Following production of the noninventive waterborne basecoat materials WBL34a and WBL34b, using the mixing varnishes ML9 and ML10, respectively, it emerged that following incorporation of the respective effect pigment premix I into the “aqueous phase”, these waterborne basecoat materials had a multiplicity of bits, this being undesirable. In contrast, the inventive basecoat material WBL34, produced using an inventive effect pigment premix I including the mixing varnish ML6, has no bits at all. These results show that, only as a result of the production process, WBL34 has different properties from WBL34a and WBL34b.

7. Studies and Comparison of the Storage Stability of Some of Effect Pigment Premixes AS1 to AS30

7.1 The studies on some of effect pigment premixes AS1 to AS20 for storage stability took place in accordance with the method described above. Table 7.1 summarizes the results.

Table 7.1: Results of the studies into storage stability of some of effect pigment premixes AS1 to AS20

Sample Inventive Serum formed Notes

TABLE 7.1
Results of the studies into storage stability of
some of effect pigment premixes AS1 to AS20

| | Sample | Inventive | Serum formed | Notes |
|---|---|---|---|---|
| Stapa ® | AS1 | no | 12% | dark serum phase |
| Hydrolux | AS2 | no | 6% | grayish serum phase |
| 600 | AS4 | yes | 0% | |
| | AS5 | yes | 0% | |
| Stapa ® | AS6 | no | 36% | grayish yellow |
| | | | | serum phase |
| Hydrolan | AS7 | no | 10% | dark serum phase |
| 701 | AS9 | yes | 0% | |
| | AS10 | yes | 0% | |
| Stapa ® | AS11 | no | 36% | dark serum phase; |
| Hydrolux | | | | Alu pigment |
| | | | | forms sediment |
| | AS12 | no | 68% | dark gray serum |
| | | | | phase |
| 2153 | AS14 | yes | 0% | |
| | AS15 | yes | 0% | |
| Stapa ® | AS16 | no | 34% | pale yellow serum |
| | | | | phase |
| Hydrolan | AS17 | no | 72% | dark serum phase; |
| | | | | Alu pigment |
| | | | | forms sediment |
| 2153 | AS19 | yes | 0% | |
| | AS20 | yes | 0% | |

The effect pigment premixes based on the inventive mixing varnishes ML5 and ML7 (as used for producing AS4-AS5, AS9-10, AS14-15) have outstanding storage stability. An effect pigment premix using a polyester resin and butyl glycol or using the noninventive mixing varnish ML1 (produced in a method based on patent EP 1 799 783 B1), in contrast, showed in some cases drastic serum formation, depending on the pigment used.

7.2 The studies on some of effect pigment premixes AS21 to AS28 for storage stability took place in accordance with the method described above. Table 7.2 summarizes the results.

Table 7.2: Results of the studies into storage stability of some of effect pigment premixes AS21 to AS28 (all inventive)

TABLE 7.2
Results of the studies into storage stability of some of
effect pigment premixes AS21 to AS28 (all inventive)

| | | Sample | Serum formed | Notes |
|---|---|---|---|---|
| Alu:ML = 30:70 | Stapa ® | AS21 | 0% | |
| Alu:ML = 40:60 | Hydrolux | AS23 | 0% | |
| | 600 | AS24 | 0% | |
| Alu:ML = 30:70 | Stapa ® | AS25 | 0% | |
| Alu:ML = 40:60 | Hydrolan | AS27 | 0% | |
| | 2153 | A528 | 0% | |

All of premixes AS21, AS23 to AS25 and AS27 to AS28 studied have outstanding storage stability.

7.3 The studies on the effect pigment premixes AS29 and AS30 for storage stability took place in accordance with the method described above. Table 7.3 summarizes the results.

Table 7.3: Results of the studies into storage stability of effect pigment premixes AS29 and AS30 (both inventive)

TABLE 7.3
Results of the studies into storage stability of effect
pigment premixes AS29 and AS30 (both inventive)

| Sample | Serum formed | Notes |
|---|---|---|
| AS29 | 0% | no sedimentation/floating of pigment; no |
| | | residues on filtration after 2 weeks |
| AS30 | 0% | no sedimentation/floating of pigment; no |
| | | residues on filtration after 2 weeks |

It is apparent that iron oxide-coated aluminum pigments, obtainable for example under the tradename Paliocrom® from BASF SE, can be processed using inventive mixing varnish ML6 to form a stable premix which even after filtration exhibits no residues such as pigment agglomerates, for example, as a consequence of inadequate stabilization.

8. Studies and Comparison of the Properties of the Aqueous Basecoat Materials and of the Coatings Obtained from them

8.1 Comparison Between WBL1, WBL2, WBL4 and WBL4 (all Noninventive) and Waterborne Basecoat Materials WBL3 and WBL6 (Both Inventive; Each Comprising Inventive Mixing Varnish ML3) with Regard to Flop and the Incidence of Pops

The studies on WBL1 to WBL6 with regard to flop and the incidence of pops took place in accordance with the methods described above. Tables 8.1 and 8.2 summarize the results.

Table 8.1: Results of the Studies into Flop

TABLE 8.1
Results of the studies into flop

| | Waterborne basecoat material | | | | | |
|---|---|---|---|---|---|---|
| | WBL1 | WBL2 | WBL3 | WBL4 | WBL5 | WBL6 |
| Flop index | 16.6 | 16.7 | 16.5 | 12.6 | 12.7 | 12.8 |

Table 8.2: Results of the Studies into the Popping Limit

TABLE 8.2
Results of the studies into the popping limit

| | Waterborne basecoat material | | |
|---|---|---|---|
| | WBL4 | WBL5 | WBL6 |
| Popping limit: | 28 μm | 30 μm | 28 μm |

The use of inventive mixing varnish ML3 in comparison to the prior art, i.e., in comparison to a premix of the pigments in a polyester resin in combination with butyl glycol (WBL1 and WBL4) and, respectively, with mixing varnish ML2, produced in a method based on patent EP 1 534 792 B1, column 11, lines 1-13 (WBL2 and WBL5), leads to comparable results with regard to the flop in each case. The sensitivity to popping as well is not adversely affected by the mixing varnish ML3 used in the production of WBL3 and WBL6.

8.2 Comparison Between WBL7 and WBL10 (Noninventive) and Waterborne Basecoat Materials WBL8 and WBL9 (Comprising Inventive Mixing Varnish ML4) and, Respectively, WBL11 and WBL12 (Comprising Inventive Mixing Varnish ML5) in Terms of Flop

The studies on WBL7 to WBL12 with regard to flop took place in accordance with the method described above.

TABLE 8.3
Results of the studies into flop

| | Waterborne basecoat material | | | | | |
|---|---|---|---|---|---|---|
| | WBL7 | WBL8 | WBL9 | WBL10 | WBL11 | WBL12 |
| Flop index | 14.7 | 14.8 | 14.8 | 11.4 | 11.4 | 11.4 |

With regard to the flop, the result achievable with inventive mixing varnishes ML4 and ML5, which are used in the production of WBL8 and WBL11, and WBL9 and WBL12, respectively, is equivalent to that achieved in comparison to the prior art (ML1, produced in a method based on patent EP 1 799 783 B1 and used in producing WBL7 and WBL10); with ML5 (and also with ML4), compared with ML1 as already described under 7.1, however, a significantly better storage stability of the effect pigment premix is achieved (cf. table 7.1: AS2, AS7, AS12 and AS17 (all containing ML1) vs. AS4, AS9, AS14 and AS19 (all containing ML5)). Furthermore, ML5 offers more freedoms in the formulation, for example, of basecoat materials, since this mixing varnish contains a very small fraction of organic solvents (about 5 wt %).

8.3 Comparison Between WBL13 to WBL15, WBL18 to WBL20, WBL23 to WBL25 and WBL28 to WBL30 (all not Inventive) and Waterborne Basecoat Materials WBL16 and WBL17, WBL21 and WBL22, WBL26 and WBL27, and WBL31 and WBL32, with Regard to Hue and Flop

The investigations of WBL13 to WBL32 with regard to flop and hue, respectively, took place in accordance with the method described above. Table 8.4 summarizes the results.

TABLE 8.4
Results of the studies into flop and hue
(in relation to the solids content found)

| | | | | | Flop | Solids |
|---|---|---|---|---|---|---|
| | Sample | L*_{15°} | L*_{45°} | L*_{110°} | index | content |
| Stapa ® | WBL13 | 127.1 | 63.8 | 35.5 | 11.4 | 16.9% |
| Hydrolux 600 | WBL14 | 127.3 | 64.6 | 36.6 | 11.1 | 14.7% |
| | WBL15 | 124.4 | 64.2 | 35.8 | 10.9 | 17.6% |
| | WBL16 | 125.6 | 64.0 | 35.6 | 11.1 | 18.4% |
| | WBL17 | 125.0 | 64.4 | 36.3 | 10.9 | 17.7% |
| Stapa ® | WBL18 | 127.5 | 65.5 | 33.3 | 11.5 | 17.3% |
| Hydrolan 701 | WBL19 | 128.7 | 65.4 | 32.7 | 11.7 | 15.7% |
| | WBL20 | 125.0 | 66.2 | 33.6 | 11.0 | 17.6% |
| | WBL21 | 125.9 | 66.0 | 33.6 | 11.1 | 18.6% |
| | WBL22 | 125.8 | 66.0 | 33.6 | 11.1 | 18.2% |
| Stapa ® | WBL23 | 151.1 | 52.6 | 30.5 | 18.2 | 17.4& |
| Hydrolux 2153 | WBL24 | 152.7 | 51.1 | 31.0 | 18.9 | 16.0% |
| | WBL25 | 146.1 | 55.5 | 32.5 | 16.3 | 18.1% |
| | WBL26 | 150.0 | 53.0 | 31.0 | 17.8 | 18.6% |
| | WBL27 | 150.2 | 52.5 | 30.7 | 18.0 | 17.9% |
| Stapa ® | WBL28 | 153.5 | 51.0 | 29.4 | 19.3 | 19.8% |
| Hydrolan 2153 | WBL29 | 155.3 | 49.5 | 30.0 | 20.0 | 16.3% |
| | WBL30 | 152.4 | 52.3 | 30.2 | 18.5 | 18.3% |
| | WBL31 | 154.0 | 51.4 | 29.4 | 19.2 | 19.2% |
| | WBL32 | 154.4 | 50.6 | 29.2 | 19.6 | 18.2% |

The results demonstrate that by means of inventive mixing varnish ML7 it is possible in each case to achieve flop effects which are situated at the same level as for the reference materials. In general, furthermore, the waterborne basecoat materials based on ML7 have higher solids contents than the comparative basecoat materials. The use of noninventive mixing varnish ML2, in particular, does lead to very good orientation of the effect pigments, but likewise to a lower solids content, owing to the relatively high fraction of thickener, which must be compensated with water in order to set the spray viscosity.

8.4 Comparison Between Noninventive Waterborne Basecoat Material WBL33 and Waterborne Basecoat Material WBL34 (Containing Inventive Mixing Varnish ML6) in Terms of (Refinish) Adhesion Properties in Different Coating Systems and Also in Appearance Before and after Condensation Exposure

The studies on WBL33 and WBL34 took place in accordance with the methods described above. Tables 8.5 and 8.6 summarize the results.

TABLE 8.5
Results of the studies on waterborne basecoat materials WBL33 and
WBL34 in terms of appearance before and after condensation exposure

| | System a | | System b | | System c | | System A | | System B | |
|---|---|---|---|---|---|---|---|---|---|---|
| | WBL33 | WBL34 | WBL33 | WBL34 | WBL33 | WBL34 | WBL33 | WBL34 | WBL33 | WBL34 |
| Before condensation | | | | | | | | | | |
| exposure | | | | | | | | | | |
| LW: | 7.6 | 8.1 | 6.0 | 6.4 | 6.3 | 6.7 | 5.2 | 4.8 | 5.0 | 5.8 |
| SW: | 18.9 | 21.0 | 17.9 | 17.8 | 29.1 | 28.4 | 14.0 | 18.5 | 13.9 | 15.9 |
| DOI: | 88.9 | 87.5 | 89.1 | 88.9 | 85.1 | 85.3 | 90.4 | 88.8 | 89.3 | 88.7 |
| After condensation | | | | | | | | | | |
| exposure | | | | | | | | | | |
| LW: | 5.6 | 7.2 | 5.7 | 5.3 | 6.5 | 6.0 | 5.8 | 2.9 | 6.3 | 4.7 |
| SW: | 25.4 | 18.6 | 18.5 | 17.4 | 27.3 | 30.0 | 14.6 | 13.9 | 14.9 | 13.5 |
| DOI: | 86.1 | 89.0 | 87.3 | 88.2 | 85.8 | 85.0 | 89.3 | 90.5 | 89.0 | 90.5 |
| Swelling/ | m0/ | m0/ | m0/ | m0/ | m0/ | m0/ | m0/ | m0/ | m0/ | m0/ |
| blisters: | g0 | g0 | g0 | g0 | g0 | g0 | g0 | g0 | g0 | g0 |

The use of inventive mixing varnish ML6 in comparison to the prior art (ML2, produced in a method based on patent EP 1 534 792 B1, column 11, lines 1-13) has no adverse effect on the appearance before and after condensation. All coating systems were free from blisters and swelling and gave comparable measurements.

TABLE 8.6
Results of the studies on waterborne basecoat materials WBL33 and
WBL34 in terms of adhesion before and after condensation exposure

| After condensation | System a | | System b | | System c | | System A | | System B | |
|---|---|---|---|---|---|---|---|---|---|---|
| exposure | WBL33 | WBL34 | WBL33 | WBL34 | WBL33 | WBL34 | WBL33 | WBL34 | WBL33 | WBL34 |
| Stone-chip adhesion: | KW 2 | KW 2 | KW 2 | KW 2 | KW 2 | KW 2 | KW 2 | KW 2 | KW 2 | KW 2 |
| Steam jet on stone-chip: | KW 1 | KW 1.5 | KW 1 | KW 1 | KW 2 | KW 1.5 | KW 1.5 | KW 2 | KW 2 | KW 2 |

The adhesion properties as well were found to be comparable; with regard to the stone-chip adhesion, identical values were found across all coating systems both for waterborne basecoat material WBL33 (containing noninventive mixing varnish ML2) and for WBL34 (containing inventive mixing varnish ML6). Within the fluctuation range expected by the skilled person in the measurements, the values for the steam-jet test on stone-chip can also be interpreted as being comparable.

1. An aqueous effect pigment paste comprising:
(a) at least one effect pigment; and
(b) at least one polymer having an average particle size in the range from 100 to 500 nm, preparable by successive radical emulsion polymerization of three monomer mixtures (A), (B) and (C) of olefinically unsaturated monomers in water,
wherein:
the mixture (A) comprises at least 50 wt % of monomers having a solubility in water of less than 0.5 g/l at 25° C., and a polymer prepared from the mixture (A) possesses a glass transition temperature of 10 to 65° C.,
the mixture (B) comprises at least one polyunsaturated monomer, and a polymer prepared from the mixture (B) possesses a glass transition temperature of −35 to 15° C., and
a polymer prepared from the mixture (C) possesses a glass transition temperature of −50 to 15° C.,
and wherein:
i. first the mixture (A) is polymerized,
ii. then the mixture (B) is polymerized in the presence of the polymer prepared under i., and
iii. thereafter the mixture (C) is polymerized in the presence of the polymer prepared under ii.

2. The effect pigment paste as claimed in claim 1, which comprises the effect pigment (a) in an amount of at least 10 wt %, based on a total weight of the effect pigment paste.

3. The effect pigment paste as claimed in claim 1, wherein at least one effect pigment (a) comprises a metallic effect pigment and/or a metal oxide-on-mica pigment.

4. The effect pigment paste as claimed in claim 1, wherein at least one effect pigment (a) comprises an aluminum pigment.

5. The effect pigment paste as claimed in claim 1, wherein a relative weight ratio of the at least one effect pigment (a) to the polymer (b) in the effect pigment paste is in a range from 10:1 to 1:1.

6. The effect pigment paste as claimed in claim 1, which comprises the polymer (b) in an amount in a range from 1.5 to 20 wt %, based on a total weight of the effect pigment paste.

7. The effect pigment paste as claimed in claim 1, wherein a fraction of the mixture (A) used for preparing the polymer (b) is from 0.1 to 10 wt %, a fraction of the mixture (B) used for preparing the polymer (b) is from 60 to 80 wt %, and a fraction of the mixture (C) used for preparing the polymer (b) is from 10 to 30 wt %, based in each case on a sum of individual amounts of the mixtures (A), (B) and (C).

8. The effect pigment paste as claimed in claim 1, wherein the mixture (A) comprises at least one monounsaturated ester of (meth)acrylic acid with an alkyl radical and at least one monoolefinically unsaturated monomer containing vinyl groups and having, arranged on the vinyl group, a radical which is aromatic or which is mixed saturated-aliphatic-aromatic, in which case the aliphatic fractions of the radical are alkyl groups.

9. The effect pigment paste as claimed in claim 1, wherein the mixture (B), besides the at least one polyolefinically unsaturated monomer, further comprises at least one monounsaturated ester of (meth)acrylic acid with an alkyl radical and at least one monoolefinically unsaturated monomer containing vinyl groups and having, arranged on the vinyl group, a radical which is aromatic or which is mixed saturated-aliphatic-aromatic, in which case the aliphatic fractions of the radical are alkyl groups.

10. The effect pigment paste as claimed in claim 1, wherein the mixtures (A) and (B) contain no hydroxy-functional monomers and no acid-functional monomers.

11. The effect pigment paste as claimed in claim 1, wherein the mixture (C) comprises at least one alpha-beta unsaturated carboxylic acid, at least one monounsaturated ester of meth(acrylic) acid having an alkyl radical substituted by a hydroxyl group, and at least one monounsaturated ester of (meth)acrylic acid having an alkyl radical.

12. The effect pigment paste as claimed in claim 1, wherein metered addition of the olefinically unsaturated monomers in stages i. to iii. for preparing the polymer (b) takes place in such a way that in the reaction solution a fraction of free monomers does not exceed 6.0 wt %, based on a total amount of the monomers used in the respective polymerization stage, throughout the reaction time.

13. An aqueous basecoat material, wherein the basecoat material is preparable by admixing at least one effect pigment paste as claimed in claim 1 as component (1) to at least one aqueous component (2) that is suitable for preparing a basecoat material and that comprises at least one polymer that can be used as binder, wherein the at least one polymer is useable as binder comprising the polymer (b) also present in the effect pigment paste, and/or comprising at least one polymer different therefrom.

14. A method for producing a multicoat paint system, by
(1a) applying an aqueous basecoat material to a substrate,
(2a) forming a polymer film from the coating material applied in stage (1a),
(1b) optionally applying a further aqueous basecoat material to the polymer film thus formed,
(2b) optionally forming a polymer film from the coating material applied in stage (1b),
(3) applying a clearcoat material to the resultant basecoat film(s), and subsequently
(4) jointly curing the basecoat film(s) together with the clearcoat film,
wherein the basecoat material as claimed in claim 13 is used in stage (1a) or—if the method further comprises stages (1b) and (2b)—in stage (1a) and/or (1b).

15. A method of using a polymer having a particle size in the range from 100 to 500 nm, preparable by successive radical emulsion polymerization of three monomer mixtures (A), (B) and (C) of olefinically unsaturated monomers in water,
wherein:
the mixture (A) comprises at least 50 wt % of monomers having a solubility in water of less than 0.5 g/l at 25° C., and a polymer prepared from the mixture (A) possesses a glass transition temperature of 10 to 65° C.,
the mixture (B) comprises at least one polyunsaturated monomer, and a polymer prepared from the mixture (B) possesses a glass transition temperature of −35 to 15° C., and
a polymer prepared from the mixture (C) possesses a glass transition temperature of −50 to 15° C.,
and wherein:
i. first the mixture (A) is polymerized,
ii. then the mixture (B) is polymerized in the presence of the polymer prepared under i., and
iii. thereafter the mixture (C) is polymerized in the presence of the polymer prepared under ii,
the method comprising using the polymer for dispersing effect pigments within an aqueous effect pigment paste.
